(19) United States
(12) Patent Application Publication
(10) Pub. No.: US 2025/0116019 A1
(43) Pub. Date: Apr. 10, 2025

(54) MIXED METAL IRIDIUM RUTHENIUM MOLYBDENUM ELECTROCATALYSTS

(71) Applicant: MATTIQ, Inc., Skokie, IL (US)

(72) Inventors: Andrey IVANKIN, Chicago, IL (US); Jordan H. SWISHER, Chicago, IL (US); Alexander P. MANTIS, Brookfield, IL (US); Sari M. ZERAH, Chicago, IL (US); Carolin B. WAHL, Evanston, IL (US); Kevin J. KLUNDER, Chicago, IL (US); Jaime E. AVILES ACOSTA, Chicago, IL (US); Sarah M. REHN, Chicago, IL (US)

(21) Appl. No.: 18/911,078

(22) Filed: Oct. 9, 2024

Related U.S. Application Data
(60) Provisional application No. 63/543,175, filed on Oct. 9, 2023.
(60) Provisional application No. 63/561,430, filed on Mar. 5, 2024.
(60) Provisional application No. 63/639,095, filed on Apr. 26, 2024.

(51) Int. Cl. C25B 11/089; C22C 27/04; C22C 28/00; C25B 1/02; C25B 1/26; C25B 1/27; C25C 7/02; C25D 17/10

(52) U.S. Cl. CPC C25B 11/089; C22C 27/04; C22C 28/00; C25B 1/02; C25B 1/26; C25B 1/27; C25C 7/02; C25D 17/10

(57) ABSTRACT

The present disclosure includes mixed metal catalysts, including electrocatalysts which can be applied to reduce the need for Ir, while exhibiting desirable performance. Mixed metal electrocatalyst materials of the invention catalysts comprising Ir, Ru and Mo, catalysts comprising Ru and Mo, and catalysts comprising Ir and Mo.

### CROSS-REFERENCE TO RELATED APPLICATION

This application claims priority to U.S. Provisional Application Ser. No. 63/543,175, filed on Oct. 9, 2023, Ser. No. 63/561,430, filed Mar. 3, 2024, Ser. No. 63/639,095, filed Apr. 26, 2024, the entire contents of which are incorporated herein by reference.

### TECHNICAL FIELD

The present disclosure concerns electrocatalyst materials. More specifically, the present disclosure concerns mixed metal electrocatalyst materials.

### BACKGROUND

Green hydrogen is one of the most promising energy sources to replace traditional fossil fuels, but slow reaction kinetics plague the anodic oxygen evolution reaction (OER), leading to poor water splitting efficiency. A catalyst material used for anodic oxygen evolution must withstand strong oxidizing potentials in harsh acidic environments while maintaining good activity. State-of-the-art catalyst materials RuO_{X} and IrO_{X} either have poor corrosion resistance or are expensive owing to their ultra-scarcity. Electrocatalyst materials that reduce cost and/or energy consumption while maintaining/exceeding the activity and durability of IrO_{X}/RuO_{X} are highly desirable for many applications, including industrial green hydrogen deployment.

### SUMMARY

The present application discloses one or more of the features recited in the claims and/or the following features which, alone or in any combination, may comprise patentable subject matter.

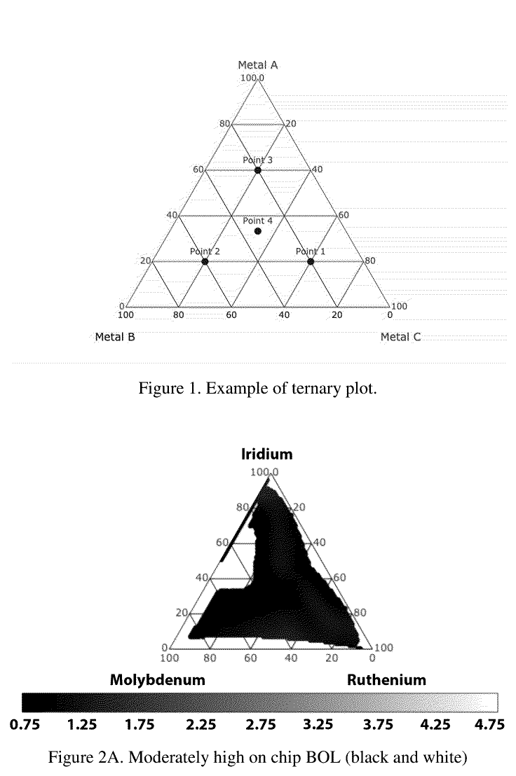

According to an aspect of the present disclosure an electrocatalyst can include a mixed single phase material comprising Ir, Ru, and Mo. In some embodiments the composition of the catalyst and atomic ratio of the metallics may be defined from at least one of those disclosed within the collection of Tables 1-15 and FIGS. 1-15.

According to another aspect of the presenting disclosure includes the preparation of catalysts according to the present disclosure. Accordingly, one aspect of the present disclosure relates to a method for the production of a mixed metal electrocatalyst material, the method comprising:
i. providing a mixture of suitable precursor metal salts in a particle size and form suitable for preparation;
ii. subjecting the mixture to a temperature in the range of 300° C. to 600° C., depending on the desired properties, under suitable gas flow conditions and for a suitable period of time;
iii. furnace cooling obtained samples to room temperature and removal of excess reagent via purification. Another aspect of the present disclosure also relates to systems comprising the electrocatalyst according to the present disclosure.

In some embodiments, one or more metals within the catalyst may be oxidized. Oxidation or lack thereof may affect the performance of the catalyst under different testing conditions. The oxide may vary in crystallinity from amorphous to fully crystalline. The crystallinity of the oxide may affect the performance of the catalyst under different testing conditions. A ratio of oxide to metallic may be fully oxidized, partially oxidized, or fully metallic. The oxide may be created via thermal annealing, calcination, or electrochemically.

In some embodiments, an electrocatalyst can include a mixed single crystallographic phase nanomaterial comprising Ir, Ru, and Mo. In other embodiments, the electrocatalyst material can include a multiphase mixed nanomaterial comprising Ir, Ru, and Mo.

In some embodiments, the catalyst may be unsupported, or supported on carbon, alumina, titanium, titania, niobium, zirconium, tantalum, antimony, silicon carbide, palladium, platinum, silica. In some embodiments, the catalyst may contain up to 10% atomic % of additional elements such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, Cu; and in some embodiments, may include other elements.

In some embodiments, the surface of the electrocatalyst may be nanostructured. In some embodiments, the mixed metallics or mixed metal oxides may be synthesized via at least one of melt fusion, templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the presenting disclosure, a method of catalyzing electrochemical reactions may include providing a mixed metal electrocatalyst including a first metal as Ir; and other metals Ru and Mo; and applying the mixed metal electrocatalyst in a reaction. In some embodiments, the composition of the electrocatalyst and the atomic ratio of the metallics may be defined from at least one of those disclosed within the collection of Tables 1-15 and FIGS. 1-15.

In some embodiments, one or more metallics within the catalyst may be oxidized. The oxide may have crystallinity within the range of amorphous to fully crystalline. A ratio of oxide to metallic components may be fully oxidized, partially oxidized, or fully metallic. The oxide may be generated via thermal fusion/annealing, calcination, or electrochemical oxidation. The catalyst may be unsupported, or supported on carbon, alumina, titanium, titania, niobium, zirconium, tantalum, antimony, silicon carbide, palladium, platinum, silica; and in some embodiments may include other elements.

In some embodiments, the catalyst may contain up to 10 atomic % of additional metallic elements such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, and/or Cu.

In some embodiments, the surface of the catalyst may be nanostructured. The mixed metallics or mixed metal oxides may be synthesized via at least one of melt fusion templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the present disclosure, a method of catalyzing electrochemical reactions may include providing a mixed metal including a first metal as Ir and other metals Ru and Mo, and applying the mixed metal electrocatalyst in a reaction. In some embodiments, applying the catalyst in a reaction may include applying the catalyst for the oxygen evolution reaction (OER). The OER reaction may be an acidic OER. In some embodiments, the OER reaction may be an alkaline OER.

In some embodiments, applying the catalyst in a reaction may include applying the catalyst as an electrode material for electrocatalytic hydrogen generation and/or oxidation in place of other noble/platinum group metals. Applying the catalyst in a reaction may include applying the catalyst as an electrode material for electrocatalytic oxygen generation and reduction in place of other noble/platinum group metals. Applying the catalyst in a reaction may include applying the catalyst as an electrode material for electrocatalytic CO₂ conversion in place of other noble/platinum group metals. Applying the catalyst in a reaction may include applying the catalyst as an electrode material for electrocatalytic biomass conversion in place of other noble/platinum group metals. Applying the catalyst in a reaction may include applying the catalyst as an electrode material for electrocatalytic hydrogenation and/or dehydrogenation in place of other noble/platinum group metals.

In some embodiments, applying the catalyst in a reaction may include applying the catalyst for gas purification. Applying the catalyst in a reaction may include applying the catalyst for deoxygenation, dehydrogenation, and/or CO₂ cleaning. Applying the catalyst in a reaction may include electroplating, electrowinning, or wastewater purification.

Additional features, which alone or in combination with any other feature(s), including those listed above and those listed in claims, may comprise patentable subject matter and will become apparent to those skilled in the art upon consideration of the following detailed description of illustrative embodiments exemplifying the best mode of carrying out the invention as presently perceived.

### BRIEF DESCRIPTION

The detailed description particularly refers to the accompanying figures in which:

FIG. 1 is an example of a ternary plot.

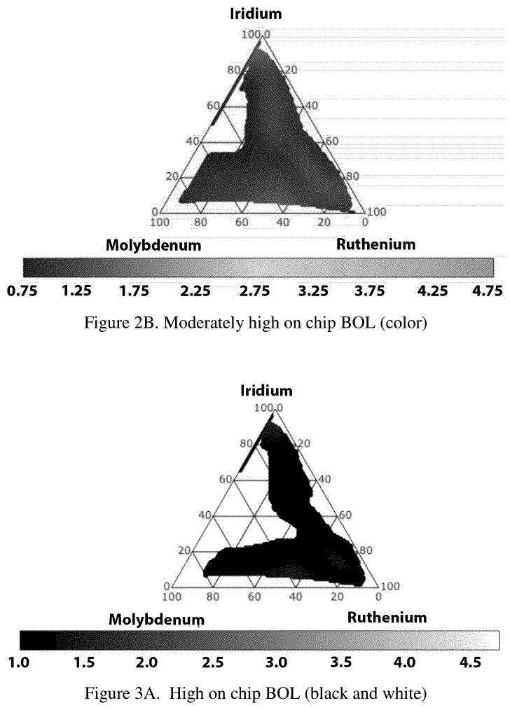

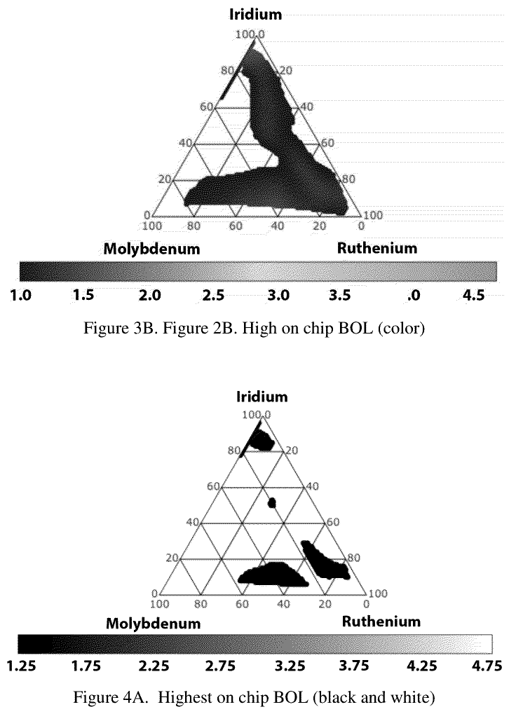

FIGS. 2A & 2B are each a graphical depiction of moderately high beginning of life (BOL) activity according to the illustrative embodiments, in black & white and color, respectively;

FIGS. 3A & 3B are each a graphical depiction of high beginning of life (BOL) activity according to the illustrative embodiments, in black & white and color, respectively;

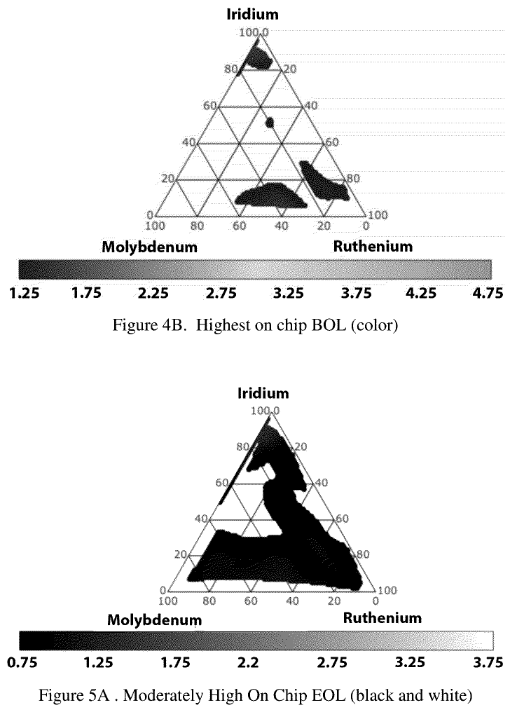

FIGS. 4A & 4B are each a graphical depiction of the highest beginning of life (BOL) activity according to the illustrative embodiments, in black & white and color, respectively;

FIGS. 5A & 5B are each a graphical depiction of moderately high end of life (EOL) activity according to the illustrative embodiments, in black & white and color, respectively;

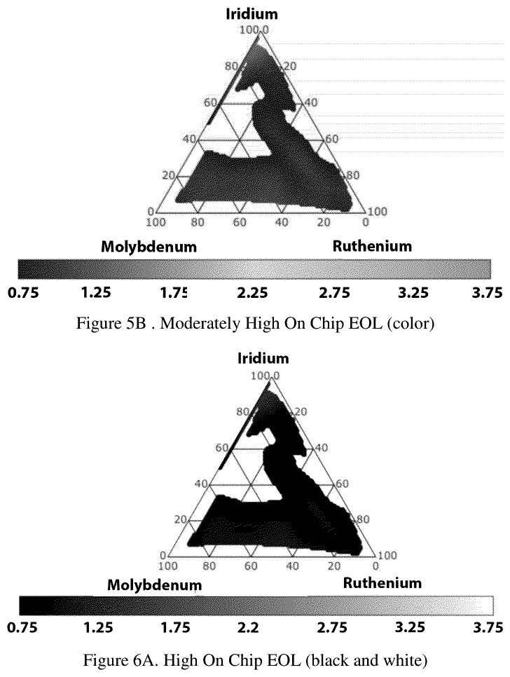

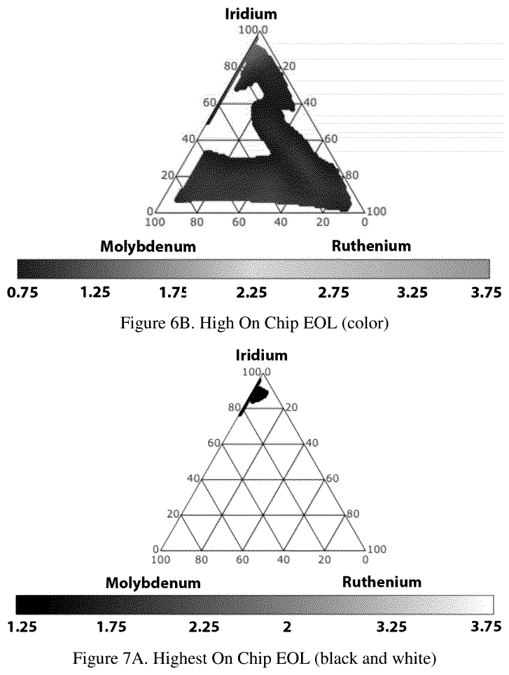

FIGS. 6A & 6B are each a graphical depiction of high end of life (EOL) activity according to the illustrative embodiments, in black & white and color, respectively;

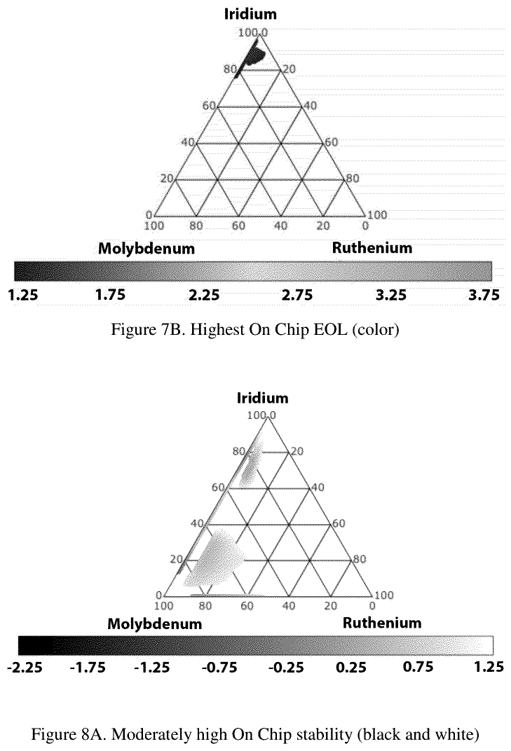

FIGS. 7A & 7B are each a graphical depiction of the highest end of life (EOL) activity according to the illustrative embodiments, in black & white and color, respectively;

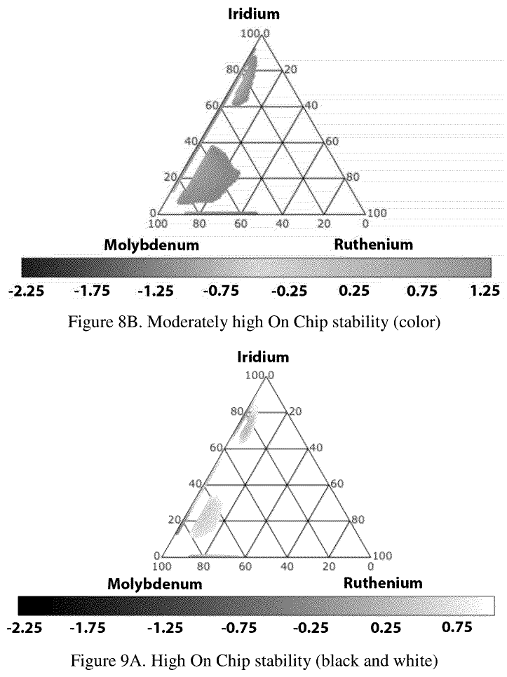

FIGS. 8A & 8B are each a graphical depiction of moderately high stability according to the illustrative embodiments, in black & white and color, respectively;

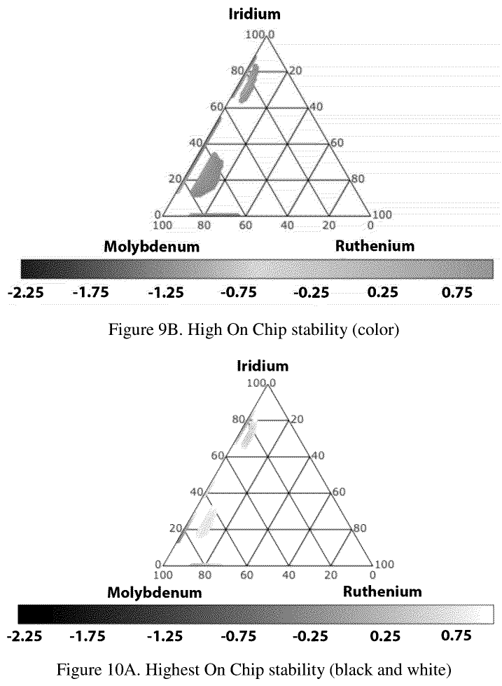

FIGS. 9A & 9B are each a graphical depiction of high stability according to the illustrative embodiments, in black & white and color, respectively;

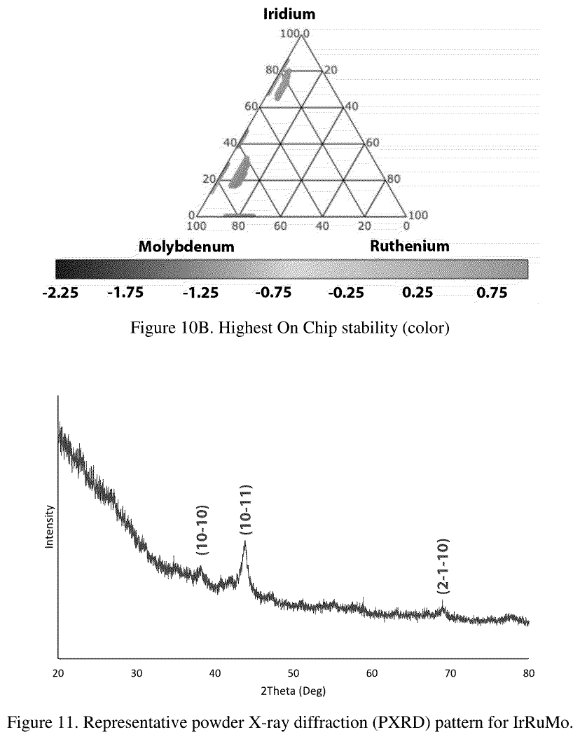

FIGS. 10A & 10B are each a graphical depiction of moderately high stability according to the illustrative embodiments, in black & white and color, respectively;

FIG. 11 is a representative powder x-ray diffraction (PXRD) plot from a representative novel catalyst sample, indexed to a single crystallographic phase, according to the illustrative embodiment;

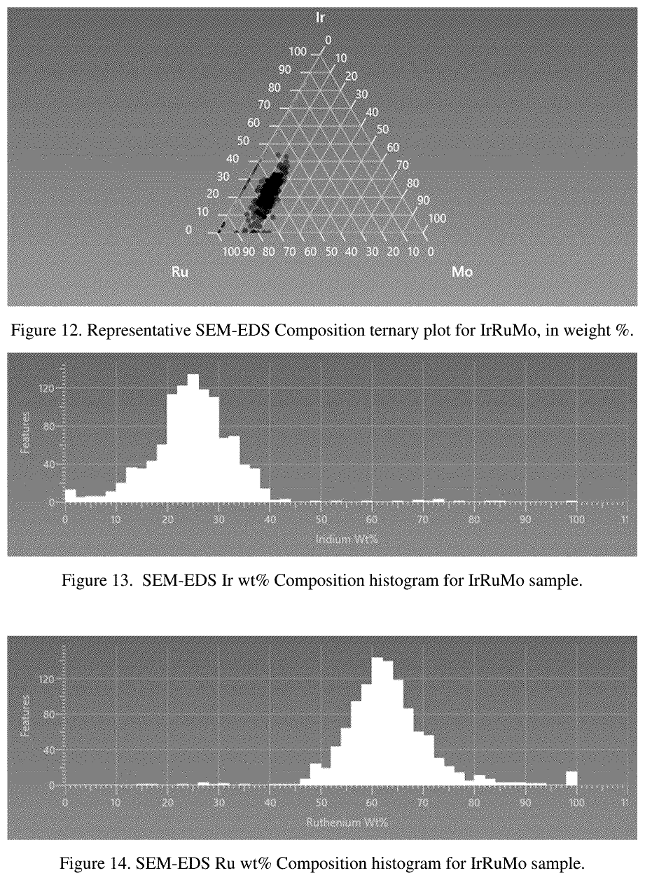

FIG. 12 is a graphical depiction of the composition collected by scanning electron microscopy coupled with energy dispersive x-ray spectroscopy (SEM-EDS) from a representative novel catalyst sample according to the illustrative embodiment.

FIG. 13 is a graphical depiction of the distribution of iridium (wt %) from a representative novel catalyst sample according to the illustrative embodiment.

FIG. 14 is a graphical depiction of the distribution of ruthenium (wt %) from a representative novel catalyst sample according to the illustrative embodiment.

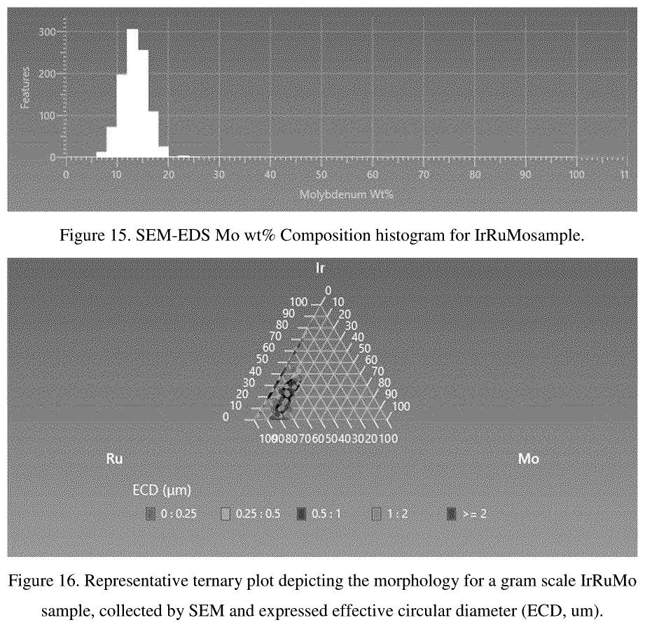

FIG. 15 is a graphical depiction of the distribution of tungsten (wt %) from a representative novel catalyst sample according to the illustrative embodiment.

FIG. 16 is a graphical depiction of the effective circular diameter (ECD) in μm collected by scanning electron microscopy (SEM) from a novel catalyst sample according to the illustrative embodiment.

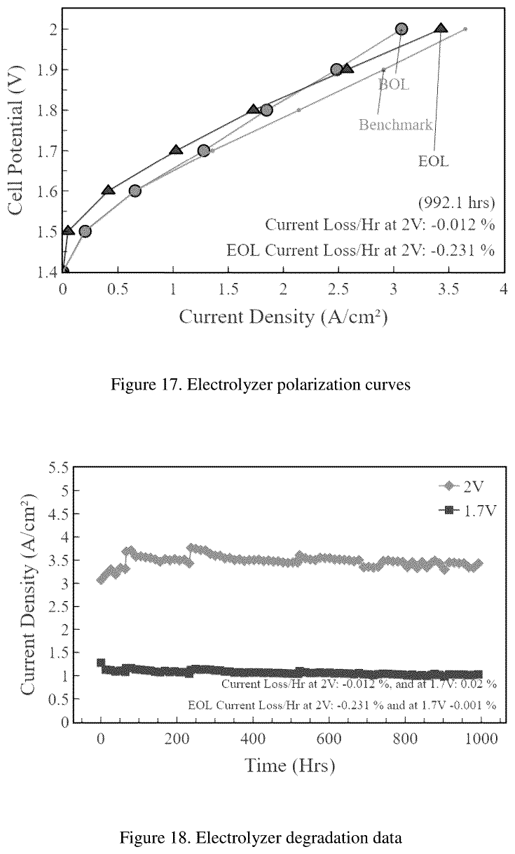

FIG. 17 is a collection of PEM electrolyzer linear polarization curves from novel catalyst samples according to the illustrative embodiment.

FIG. 18 is a collection of PEM electrolyzer degradation data from novel catalyst samples according to the illustrative embodiment.

### DETAILED DESCRIPTION

With advances in sustainable energy generation, green hydrogen is becoming an attractive option as an alternative to traditional fossil fuels. One method for the production of green hydrogen requires polymer electrolyte membrane (PEM) electrolyzers, wherein a proton-conducting membrane serves as the electrolyte that separates the anode and the cathode.

In PEM electrolyzers, the anode performs the oxygen evolution reaction (OER), which oxidizes water into O_{2(g)} and H⁺_{(aq)}. While a portion of generated protons do subsequently cross the membrane to the cathode and are consumed in the hydrogen evolution reaction (HER), the pH at the anode is harshly acidic and requires a robust anode electrocatalyst material.

There are few materials that both demonstrate high activity for the OER reaction and are stable under the highly oxidative potentials and low pH at the anode (as indicated by Pourbaix diagrams). The standard anode material of the PEM electrolysis industry is iridium oxide (IrOₓ), as it is both active and durable during industrial electrolyzer operation. However, iridium is ultra-scarce and annual production falls short of projected need given the current growth of the market. Therefore, an iridium alternative that is sufficiently stable and active in PEM water electrolyzers can enable PEM water electrolyzer growth without severe hampering from supply chain limitations.

Alloying of metals and metal oxides is a promising strategy for enhancing the performance of electrocatalysts towards OER When two or more metals or metal oxides alloy, the physical and electronic properties of active sites can change. These property changes can lower the binding energy of intermediates and, as such, lower the overpotential necessary to operate the reaction and/or stabilize the crystallographic lattice under acidic operation.

Platinum group metals (PGMs), such as iridium (Ir) and ruthenium (Ru), can act as electrocatalysts for OER. IrOₓ has a comparatively lower electrocatalytic activity but is significantly more stable at low pH and high oxidative potentials. Consequently, many alloy OER electrocatalysts are Ir- or Ru-based materials.

Among the discoveries of the present disclosure, combinations of Mo with Ir and Ru of various valence and/or morphological characteristics in two, three, or more element combinations can be applied. Such combinations can yield low-Ir or Ir-free catalysts with similar or enhanced performance compared with IrOₓ in terms of activity, stability, or both. Most electrocatalysts of mixed composition are often comprised of multiple phases due to fundamental principles underlying the material formation and oxidation processes. Of these, one phase is generally more active towards a given reaction and is thus desired as a formation target. The present disclosure includes electrocatalysts with crystallographic features indexing to a single phase. In other embodiments of the present invention, the electrocatalyst can include multiple phases.

Using polymer pen lithography, combinations were synthesized of bi- and trimetallic Ir_{X}Mo_{Y}, Ru_{X}Mo_{Y} and Ir_{X}Ru_{Y}Mo_{Z}. For these compositions, X, Y, and Z are at % (atomic ratio, % of the total number of atoms are Mᵢ atoms) and X+Y=100% for bimetallic compositions and X+Y+Z+100% for trimetallic compositions. The catalyst candidate materials were selected from the elements mentioned above with a 1 at % step change.

In the illustrative embodiment, catalyst materials were supported on doped SiC, However, in some embodiments, other supports may be applied, e.g., carbon, alumina, silica, titania, tungsten oxide, niobium oxide, indium tin oxide, fluorine-doped indium tin oxide, etc., or no support can be applied.

In addition, the presented catalyst materials were first synthesized as zero-valent metallic nanostructures and subsequently thermally oxidized. However, alternative synthesis approaches could be taken to achieve compositionally similar materials. Such compositionally similar materials may have the same or different oxidation states, shape, and/or nanostructuring.

The catalyst materials were examined for their beginning of life (BOL) and end of life (EOL) OER activity. In the illustrative embodiment, the materials were examined using high throughput scanning electrochemical methods. However, the electrochemical performance of the synthesized materials could also be measured by other means, such as rotating disk electrode (RDE testing, half-cell testing, electrolyzer testing, etc.

In the illustrative embodiment, the beginning of life (BOL) activity of catalysts toward acidic oxygen evolution reaction (OER) was measured via chronoamperometry as current generated by the catalyst when subjected, for example, to constant voltage of 2 V versus reversible hydrogen electrode (RHE) in 0.3 M HClO₄ normalized to an IrOₓ standard, however, in some embodiments, other protocols can be applied to establish the BOL of catalysts.

In the illustrative embodiment, the end of life (EOL) activity of catalysts toward acidic oxygen evolution reaction (OER) was measured via chronoamperometry as current generated by the catalyst when subjected, for example, to constant voltage of 2 V versus reversible hydrogen electrode (RHE) in 0.3 M HClO₄, normalized to an IrOₓ standard, after accelerated stress testing (AST) of the catalysts. The AST protocol can, for example, involve subjecting the catalysts to a constant voltage of 1.8 V versus reversible hydrogen electrode (RHE) for 1 hour in 0.1 M HClO₄. However, in some embodiments, other EOL activity measurement and AST protocols can be applied.

In the illustrative embodiment, the stability of catalysts toward acidic oxygen evolution reaction (OER) was calculated as (EOL_{catalyst}−BOL_{catalyst})/BOL_{catalyst} normalized (EOL_{IrOx}−BOL_{IrOx})/BOL_{IrOx}, however, in some embodiments, other formulas can be applied to establish the stability of catalysts.

Using melt fusion and/or templated thermal decomposition, combinations were synthesized of bi- and trimetallic Ir_{X}Mo_{Y} and Ir_{X}Ru_{Y}Mo_{Z}. For these compositions, X, Y, and Z are at % (atomic ratio, % of the total number of atoms are Mᵢ atoms) and X+Y=100% for bimetallic compositions and X+Y+Z+100% for trimetallic compositions These compositions were selected for gram scale synthesis from promising high throughput results.

In the illustrative embodiment, electrocatalyst materials were unsupported. However, in some embodiments, supports may be applied, e.g. carbon, alumina, titanium, titania, niobium, zirconium, tantalum, antimony, silicon carbide, palladium, platinum; and in some embodiments support may include other elements.

In addition, presented catalyst materials were first synthesized as direct mixed metal oxides, as well as zero-valent mixed metallic nanostructures that were subsequently thermally oxidized. However, alternative synthesis approaches could be taken to achieve compositionally similar materials. Such compositionally similar materials may have the same or different oxidation states, global morphology, and/or nanostructuring.

The catalyst materials were examined for the beginning of life (BOL), accelerated stress test (AST) performance, and end of life (EOL) OER activity. In the illustrative embodiment, materials were examined using small scale electrolyzer testing. However, the electrochemical performance of synthesized materials could also be measured by other means, such as rotating disk electrode (RDE) testing, half-cell testing, droplet electrochemistry, etc.

In the illustrative embodiment, the beginning of life (BOL) activity of catalysts toward acidic oxygen evolution reaction (OER) was determined from PEM electrolyzer polarization data at the onset of OER after break-in and benchmarked against an IrOₓ standard. However, in some embodiments, other protocols can be applied to establish the BOL of electrocatalysts.

In the illustrative embodiment, the performance of the novel catalyst toward acidic oxygen evolution reaction (OER) during accelerated stress testing (AST) was measured with square wave cycling and potential holds at 2 V vs RHE. The AST protocol can, for example, involve square wave voltammetry cycling potentials at 2 V and 1.45 V for 30 seconds, each. However, in some embodiments, other protocols and measurements can be applied for AST.

Specific material spaces synthesized were IrRuMo, RuMo and IrMo. Electrocatalysts described in Tables 1-15 and FIGS. 1-18 have been synthesized at either chip-scale or gram scale using a variety of techniques, including polymer pen lithography, melt fusion or templated thermal decomposition. Tables 1-13 and FIGS. 1-10 pertain to chip-scale data. Tables 14-15 and FIGS. 11-18 pertain to gram scale data.

In certain cases, variable calcination conditions have been performed on the same material composition to achieve differences in particle size, morphology, crystallinity, etc.

In certain cases, the compositional distribution can be broad or narrow, with the most optimal being dependent on the material composition.

In certain cases, the size of the material can be small (sub-100 nm particles) or larger (micron-scale), with broad and narrow size distributions. The optimal size distribution can vary depending on the material and other testing parameters.

Each of the Ir—Mo compositions described herein can be prepared such that Ir and Mo form a single mixed phase. Each of the Ir—Mo compositions described herein can also be prepared such that multiple mixed phases are formed. Each of the Ir—Mo compositions described herein can also be prepared such that no mixed (single element) phases are formed. Each of the Ir—Mo compositions described herein can also be prepared such that Ir and Mo form one mixed phase with additional single element phases present.

Each of the Ir—Ru—Mo compositions described herein can be prepared such that Ir, Ru and Mo form a single mixed phase comprising Ir, Ru and Mo. Each of the Ir—Ru—Mo compositions described herein can also be prepared such that no mixed phases are formed. Each of the Ir—Ru—Mo compositions described herein can also be prepared such that Ir, Ru and Mo form a single mixed phase with additional mixed bi- or tri-metallic phases present. Each of the Ir—Ru—Mo compositions described herein can also be prepared such that Ir, Ru and Mo form a single mixed phase with additional single element phases present. Each of the Ir—Ru—Mo compositions described herein can also be prepared such that Ir, Ru and Mo form a single mixed phase with additional mixed (bi- and tri-metallic) and single element phases present.

A typical melt fusion synthetic protocol is as follows:
catalyst precursor solution is prepared by dissolving metal precursor powders in requisite organic solvents (isopropanol, chloroform, acetonitrile, etc.) to achieve the desired ratio and concentration. This solution is combined with a large excess of either sodium nitrate alone or with accompanying salts (1-100× relative to catalyst precursor mass) to generate a slurry, dried while mixing, and transferred to an appropriate furnace crucible/boat. The precursor/salt mixture is annealed in a tube furnace in air at 350-600° C. for 1-4 hours and allowed to cool to room temperature before removal. Crude catalyst powder is then processed via several rounds of sonication, centrifugation, and washing with ultrapure water to remove excess salt and subsequently dried.

A typical templated thermal decomposition synthetic protocol is as follows:
metal precursors are dissolved in requisite organic solvents (isopropanol, chloroform, acetonitrile, etc.) to achieve the desired ratio and concentration. A finely ground inorganic salt powder (potassium sulfate, potassium chloride, sodium chloride, etc.) in the ratio of 100-2000× the mass of the dissolved metal precursors is then added to the solution to form a slurry. This slurry is dried while mixing, transferred to an appropriate furnace crucible/boat and annealed at 300-600° C. for 0.5-6 hours in either air or hydrogen in a tube furnace, with optional following calcination steps. Crude catalyst powder is then processed via several rounds of sonication, centrifugation, and washing with ultrapure water to remove excess salt and subsequently dried.

Electrocatalyst powders are characterized by scanning electron microscopy with energy-dispersive x-ray spectroscopy (SEM-EDS) and powder x-ray diffraction (PXRD). SEM-EDS indicates the material composition and homogeneity for each sample. PXRD indicates the crystallographic characteristics of each powder sample.

Electrocatalyst powders are tested via ex-situ three-electrode methods, as well as 5 cm² PEM electrolyzer tests.

A typical ex-situ three-electrode testing protocol is as follows:

catalyst powder is dispersed in a mixture of water and alcohol solvents at a concentration of 0.5-4 mg/mL. A dispersion of ionomer is then added in 0.1-12 wt % relative to catalyst powder. The mixture is sonicated for 30-90 minutes, and then applied to electrodes (glassy carbon, gold, etc.) via ultrasonicating spray deposition. The electrodes are then loaded into a three-electrode cell with 0.1-1.0 M perchloric acid and stirred vigorously. Cyclic voltammograms are run in a non-Faradaic potential regime to measure capacitance, then linear sweep voltammograms are run from 1.1-1.8 V vs. RHE to measure the OER activity. Chronoamperometry is then performed at 1.65 V vs. RHE for 5-800 minutes, followed by repeat linear sweep voltammograms. Underpotential deposition of metals (Hg, Pb, etc.) is performed to determine electrochemically active surface area (ECSA).

In some cases, alternative testing protocols can be utilized in place of chronoamperometry, including chronopotentiometry and cyclic voltammetry.

A typical PEM electrolyzer testing protocol is as follows:
catalyst powder is dispersed in a mixture of water and alcohol solvents at a concentration of 0.4-5 mg/mL. A dispersion of ionomer is then added in a 3-25 wt % relative to catalyst powder. The mixture is sonicated for 30-90 minutes, and then applied to ion exchange membranes (with Pt/C already loaded on the opposite side) with a loading of 0.1-1 mg of catalyst powder per cm². The catalyst coated membrane is assembled into a PEM electrolyzer cell with platinized Ti porous transport layers (anode) and carbon paper porous transport layers (cathode) and PTFE spacers. Ultrapure water (80° C.) is then circulated through the anode flow fields at 100 mL/min, and the assembled cell is preconditioned by a galvanostatic hold at 0.2 A/cm² for 1 hour, a galvanostatic hold at 1 A/cm² for 1 hour, a potentiostatic hold at 2 V for 30 minutes. After preconditioning, a polarization curve is collected by holding 1.3-2 V with 0.1 V steps for 5 minutes. Square wave voltammetry is then performed by holding the cell potential at 2 V for 30 seconds, 1.45 V for 30 seconds, and repeating. Every 12 hours, polarization curves are collected.

In some cases, alternative accelerated stress testing protocols can be utilized in place of square wave voltammetry, including constant voltage hold or triangle wave.

Using these methodologies, we have synthesized and validated several promising samples for acidic OER within the combinatorial materials space of Ir_{X}Ru_{Y}Mo_{Z} and Ir_{X}Mo_{Y}

Tables 1-13 summarize the results for high throughput, chip-based experiments screening many example compositions from within the material space listed above.

Tables 14-15 summarizes the average PEM electrolyzer results for example materials from within the material space listed above.

Samples generated within this materials space have performed favorably in both the three-electrode tests and PEM electrolyzer tests when compared with industry standard samples.

For three-electrode tests, important metrics can include activity and stability relative to pure iridium oxide. Activity for novel catalyst materials at gram scale is reported in Tables 14-15. The activity data in Tables 14-15 is normalized by mass of catalyst and reported as μA/μg at 1.8 V vs. RHE, collected by linear polarization. The degradation rate in Tables 14-15 is calculated the change in current (μA/μg) at the same voltage after a 10-minute hold and subsequent linear polarization. Inhomogeneities in the disclosed data may be attributed to variations in particle size, morphology, crystallinity, etc from variations in synthetic preparation.

For PEM electrolyzer tests, important metrics can include beginning of life activity, conductivity, capacitance, and degradation rates, relative to iridium oxide. BOL activity, conductivity, and degradation rates are reported in Tables 14-15. The BOL activity is determined from linear sweep experiments and reported as A/cm² at 2.0 V vs RHE. The conductivity is reported in mΩ, the degradation rates are reported as the percentage of the BOL current density lost per hour of test, and the durations are reported in hours. Inhomogeneities in the disclosed data may be attributed to variations in particle size, morphology, crystallinity, etc from variations in synthetic preparation.

In summary, Tables 1-15 show the compositional ranges and corresponding performance for the respective criteria for high throughput experiments. Columns listed as min at % show the lower compositional percentage range for each element. Columns listed as max at % show the upper compositional percentage range for each element. Each highlights various novel catalyst material combinations with at least moderately good beginning of life (BOL) and/or end of life (EOL) activity and/or relative stability normalized to an IrOₓ benchmark. Tables 14-17 highlight the performance of the disclosed novel catalyst material that outperforms pure iridium oxide, especially when considering the performance relative to the total mass of Ir. Certain samples may only have three-electrode cell data, only electrolyzer data, or both. Certain materials may have only been tested under square wave accelerated stress testing, only been tested under 2 V hold accelerated stress testing, or both. The material compositions are reported in weight percent (wt %) and are measured by scanning electron microscopy with energy dispersive x-ray spectroscopy (SEM-EDS).

Referring to Tables 1-3 and Tables 10-11, the columns listed as Upper Relative BOL Activity at Min at % show the highest Relative Beginning of Life (BOL) activity at the lowest compositional value in the range for each element. The columns listed as Upper Relative BOL Activity at Max at % show the highest Relative BOL activity at the highest compositional value in the range for each element. Referring to values in Table 1, Row 1 as an example: The compositional range is 2-91 at % for Iridium, 2-90 at % for Ruthenium, and 2-86 at % for Molybdenum. The Upper BOL Activity at Min Ir at % value of 1.0261 is the highest Relative BOL activity for materials with 2% Iridium. The Upper Relative BOL Activity at Max Ir at % value of 1.5437 is the highest Relative BOL activity for materials with 91% Iridium. The Upper Relative BOL Activity at Min Ru at % value of 1.5437 is the highest Relative BOL activity for materials with 2% Ruthenium. The Upper Relative BOL Activity at Max Ru at % value of 1.1248 is the highest Relative BOL activity for materials with 90 at % Ruthenium. The Upper Relative BOL Activity at Min Mo at % value of 1.0269 is the highest Relative BOL activity for materials with 2% Molybdenum. The Upper Relative BOL Activity at Max Mo at % value of 0.8868 is the highest Relative BOL activity for materials with 86% Molybdenum. Higher values indicate better Relative BOL activity. BOL is measured via chronoamperometry as current generated by the catalyst when subjected, for example, to constant voltage of 2 V versus reversible hydrogen electrode (RHE) in 0.3 M HClO₄ normalized to an IrOₓ standard.

As shown in Table 1, the preferred ranges of Ir—Ru—Mo relative to each other to achieve moderately high beginning of life (BOL) activity are Ir (2-91 at %), Ru (2-90 at %), and Mo (2-86 at %). For Ir—Mo, the preferred ranges to achieve moderately high BOL are Ir (51-96 at %) and Mo (4-49 at %). For Ru—Mo, the preferred ranges to achieve moderately high BOL are Ru (93-94 at %) and Mo (6-7 at %). The more preferred ranges of Ir—Ru—Mo relative to each other to achieve high beginning of life (BOL) activity are Ir (2-91 at %), Ru (2-90 at %), and Mo (2-80 at %). For Ir—Mo, the more preferred ranges to achieve high BOL are Ir (66-96 at %) and Mo (4-37 at %). Even more preferred ranges of Ir—Ru—Mo relative to each other to achieve the highest beginning of life (BOL) activity are Ir (6-91 at %), Ru (2-86 at %), and Mo (3-57 at %). For Ir—Mo, even more preferred ranges to achieve the highest BOL are Ir (78-96 at %) and Mo (4-22 at %). Further preferred ranges of Ir—Ru—Mo relative to each other to achieve the highest beginning of life (BOL) activity are Ir (8-89 at %), Ru (4-84 at %), and Mo (6-20 at %). For Ir—Mo, even more preferred ranges to achieve the highest BOL are Ir (80-94 at %) and Mo (6-20 at %).

Referring to Tables 4-6 and Tables 10-11, the columns listed as Upper Relative EOL Activity at Min at % show the highest Relative End of Life (EOL) activity at the lowest compositional value in the range for each element. The columns listed as Upper Relative EOL Activity at Max at % show the highest Relative EOL activity at the highest compositional value in the range for each element. Referring to values in Table 4, Row 1 as an example: The compositional range is 2-91 at % for Iridium, 2-90 at % for Ruthenium, and 2-86 at % for Molybdenum. The Upper EOL Activity at Min Ir at % value of 0.8133 is the highest Relative EOL activity for materials with 2% Iridium. The Upper Relative EOL Activity at Max Ir at % value of 1.4226 is the highest Relative EOL activity for materials with 91% Iridium. The Upper Relative EOL Activity at Min Ru at % value of 1.4226 is the highest Relative EOL activity for materials with 2% Ruthenium. The Upper Relative EOL Activity at Max Ru at % value of 0.8798 is the highest Relative EOL activity for materials with 90 at % Ruthenium. The Upper Relative EOL Activity at Min Mo at % value of 0.8433 is the highest Relative EOL activity for materials with 2% Molybdenum. The Upper Relative EOL Activity at Max Mo at % value of 0.8606 is the highest Relative EOL activity for materials with 86% Molybdenum. Higher values indicate better Relative EOL activity. The end of EOL activity of catalysts toward acidic oxygen evolution reaction (OER) was measured via chronoamperometry as current generated by the catalyst when subjected to constant voltage of 2 V versus reversible hydrogen electrode (RHE) in 0.3 M HClO₄, normalized to an IrOₓ standard, after accelerated stress testing (AST) of the catalysts. The preferred ranges of Ir—Ru—Mo relative to each other to achieve moderately high end of life (EOL) activity are Ir (2-91 at %), Ru (2-90 at %), and Mo (2-86 at %). For Ir—Mo, the preferred ranges to achieve moderately high EOL are Ir (78-96 at %) and Mo (4-22 at %). The more preferred ranges of Ir—Ru—Mo relative to each other to achieve high end of life (EOL) activity are Ir (6-91 at %), Ru (2-71 at %), and Mo (3-79 at %). For Ir—Mo, the more preferred ranges to achieve high EOL are Ir (66-96 at %) and Mo (4-34 at %). Even more preferred ranges of Ir—Ru—Mo relative to each other to achieve the highest end of life (EOL) activity are Ir (84-91 at %), Ru (2-7 at %), and Mo (4-13 at %). For Ir—Mo, even more preferred ranges to achieve the highest EOL are Ir (77-96 at %) and Mo (4-23 at %). Further preferred ranges of Ir—Ru—Mo relative to each other to achieve the highest end of life (EOL) activity are Ir (86-89 at %), Ru (4-6 at %), and Mo (8-18 at %). For Ir—Mo, even more preferred ranges to achieve the highest EOL are Ir (79-94 at %) and Mo (6-21 at %).

Referring to Tables 7-9 and Tables 10-11, the columns listed as Upper Relative Stability at Min at % show the best Relative Stability at the lowest compositional value in the range for each element. The columns listed as Upper Relative Stability at Max at % show the best Relative Stability at the highest compositional value in the range for each element. Referring to values in Table 7, Row 1 as an example: The compositional range is 7-87 at % for Iridium, 3-27 at % for Ruthenium, and 10-86 at % for Molybdenum. The Upper Relative Stability at Min Ir at % value of 1.1063 is the highest Relative Stability for materials with 7% Iridium. The Upper Relative Stability at Max Ir at % value of 1.3171 is the highest Relative Stability for materials with 87% Iridium. The Upper Relative Stability at Min Ru at % value of 0.9256 is the highest Relative Stability for materials with 3% Ruthenium. The Upper Relative Stability at Max Ru at % value of 1.3103 is the highest Relative Stability for materials with 27 at % Ruthenium. The Upper Relative Stability at Min Mo at % value of 1.3171 is the highest Relative Stability for materials with 10% Molybdenum. The Upper Relative Stability at Max Mo at % value of 1.1548 is the highest Relative Stability for materials with 86% Molybdenum. Lower values indicate better Relative Stability. Stability is calculated as (EOL_{catalyst}-BOL_{catalyst})/BOL_{catalyst} normalized (EOL_{IrOx}−BOL_{IrOx})/BOL_{IrOx}. The preferred ranges of Ir—Ru—Mo relative to each other to achieve moderately high stability are Ir (7-87 at %), Ru (3-27 at %), and Mo (10-86 at %). For Ir—Mo, the preferred ranges to achieve moderately high stability are Ir (14-92 at %) and Mo (8-86 at %). For Ru—Mo, the preferred ranges to achieve moderately high stability are Ru (14-47 at %) and Mo (53-86 at %). More preferred ranges of Ir—Ru—Mo relative to each other to achieve high stability are Ir (12-83 at %), Ru (3-16 at %), and Mo (14-79 at %). For Ir—Mo, the preferred ranges to achieve high stability are Ir (14-88 at %) and Mo (12-86 at %). For Ru—Mo, the preferred ranges to achieve high stability are Ru (14-36 at %) and Mo (64-86 at %). Even more preferred ranges of Ir—Ru—Mo relative to each other to achieve the highest stability are Ir (17-80 at %), Ru (4-11 at %), and Mo (16-75 at %). For Ir—Mo, the preferred ranges to achieve the highest stability are Ir (14-86 at %) and Mo (14-86 at %). For Ru—Mo, the preferred ranges to achieve the highest stability are Ru (14-27 at %) and Mo (73-86 at %). Further preferred ranges of Ir—Ru—Mo relative to each other to achieve the stability are Ir (20-78 at %), Ru (5-10 at %), and Mo (20-70 at %). Further preferred ranges of Ir—Mo to achieve the highest stability are Ir (20-80 at %) and Mo (20-80 at %). Further preferred ranges of Ru—Mo to achieve the highest stability are Ru (15-20 at %) and Mo (75-80 at %).

Referring to Tables 10-11, each table reports the ranges for the preferred, more preferred, and most preferred compositions based on overall performance, respectively. The tables only include the results for the Upper Relative BOL Activity at Min at % and Max at % for each element. However, the selection of the ranges for overall performance included combined criteria for Relative BOL and Relative Stability for the compositions within each of the specified ranges. The preferred ranges of Ir—Ru—Mo relative to each other to achieve moderately high overall performance are Ir (6-84 at %), Ru (4-26 at %), and Mo (12-86 at %). For Ir—Mo, the preferred ranges to achieve moderately high overall performance are Ir (5-86 at %) and Mo (14-48 at %). More preferred ranges of Ir—Ru—Mo relative to each other to achieve high overall performance are Ir (12-80 at %), Ru (4-16 at %), and Mo (16-76 at %). For Ir—Mo, the preferred ranges to achieve moderately high overall performance are Ir (68-82 at %) and Mo (18-32 at %). Further preferred ranges of Ir—Ru—Mo relative to each other to achieve the highest overall performance are Ir (15-75 at %), Ru (8-14 at %), and Mo (20-70 at %). Further preferred ranges of Ir—Mo relative to each other to achieve the highest overall performance are Ir (70-80 at %) and Mo (20-30 at %).

Tables 12-13 indicate specific compositions that perform comparably or outperform IrOₓ in either BOL activity or stability in chip based high throughput experiments. Table 12 indicates specific compositions that demonstrate moderately high overall performance, namely, that have a BOL activity≥75% of pure IrOₓ and a stability≥75% of pure IrOₓ. Table 13 indicates preferred compositions that demonstrate high overall performance, namely, that have a BOL activity≥100% of pure IrOₓ and a stability≥100% of pure IrOₓ. The material compositions listed are binned to atomic % increments of 2%, however intermediate compositions within 2% steps are also expected to have similar performance if the compositions fall within the defined ranges.

Tables 14-15 contains average data from gram scale samples of candidate electrocatalysts with compositions in the specified preferred range. The average composition data is reported as wt % and standard deviation for each component. The performance data for gram scale candidates selected from chip based data is evaluated by 3 electrode testing, where activity is expressed in μA/μg at 1.8 V vs. RHE, determined by linear sweep, and stability is expressed as the change in current (μA/μg) at the same voltage after a 10 minute hold at 1.8 V vs RHE. The PEM electrolyzer performance of novel catalysts is evaluated with conductivity, measured by electrochemical impedance spectroscopy (EIS) measurements in mΩ, BOL activity, determined from linear polarization experiments and reported as A/cm² at 2.0 V vs RHE, and degradation rates, reported as the percentage of the BOL current density lost per hour of accelerated stress test. The preferred composition of Ir—Ru—Mo relative to each other to achieve moderately high overall electrolyzer performance is Ir (14 at %), Ru (70 at %), and Mo (17 at %). Preferred ranges of Ir—Ru—Mo relative to each other on average to achieve high overall performance are Ir (5-26 at %), Ru (61-84 at %), and Mo (6-19 at %). Even more preferred ranges of Ir—Ru—Mo relative to each other on average to achieve the highest overall performance are Ir (7-24 at %), Ru (63-82 at %), and Mo (8-17 at %). Further preferred ranges of Ir—Ru—Mo relative to each other to achieve the highest overall performance are Ir (10-20 at %), Ru (65-80 at %), and Mo (10-17 at %).

Reported material wt % values in Tables 1-15 do not account for oxygen; a typical IrO₂ catalyst material contains ˜13 wt % oxygen and 87 wt % Ir.

In some aspects of the invention, a composition comprised of Ir, Ru and Mo has preferred ranges relative to each other on average of Ir (6-25 at %), Ru (50-86 at %), and Mo (3-25 at %), with more preferred ranges on average of Ir (6-20 at %), Ru (60-86 at %), and Mo (3-23 at %), and even more preferred ranges of Ir (6-17 at %), Ru (60-80 at, %), and Mo (5-20 at %). In other aspects of the invention, a composition comprised of Ir, Ru and Mo has preferred ranges relative to each other on average of Ir (12-80 at %), Ru (4-16 at %), and Mo (16-76 at %), with more preferred ranges of Ir (12-60 at %), Ru (4-14 at %), and Mo (16-60 at %), and even more preferred ranges on average of Ir (14-40 at %), Ru (30-55 at, %), and Mo (20-55 at %). In other aspects of the invention, a composition comprised of Ir, Ru and Mo has preferred ranges relative to each other on average of Ir (5-26 at %), Ru (61-84 at %), and Mo (6-19 at %), and more preferred ranges of Ir (7-24 at %), Ru (59-82 at %), and Mo (8-17 at %). In some aspects, the preferred compositions comprised of Ir, Ru, and Mo may be made up of a single mixed crystallographic phase. In other aspects, the preferred compositions comprised of Ir, Ru, and Mo may be made up multiple mixed or single element phases.

Referring to FIG. 1, an example figure is provided to describe how to read the data presented in FIGS. 2-10. Each metal and its corresponding axis are shown where the values along the axis indicate the compositional percentage for that metal. Metal A, Metal B, and Metal C are shown in red, blue, and green, respectively. The interior gridlines also correspond to the axis of its color. Four points are depicted as examples. Point 1 indicates where the composition is 20% Metal A, 20% Metal B, and 60% Metal C. Point 2 indicates where the composition is 20% Metal A, 60% Metal B, and 20% Metal C. Point 3 indicates where the composition is 60% Metal A, 20% Metal B, and 20% Metal C. Point 4 indicates where the compositions are all equivalent and is 33.3% Metal A, 33.3% Metal B, and 33.3% Metal C.

Referring to FIGS. 2A-4B, each are a depiction of beginning of life (BOL) activity of samples is shown indicating the level of electrocatalytic activity of given ratios as indicated by the corresponding range bar. The BOL level of activity is illustratively embodied as the activity toward acidic oxygen evolution reaction (OER) of electrocatalysts composed of one, two, or three elements mixed at a given ratio from the Ir—Ru—Mo material space defined by the triangular shape. The triangle represents a specific compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the activity of IrOₓ, a value>1 is more active than IrOₓ, and a value<1 is less active than IrOₓ. In FIGS. 2A, 3A, and 4A, the black and white colorscale indicate the Relative BOL performance where white indicates higher relative performance and black indicates lower relative performance. In FIGS. 2B, 3B, and 4B, the black to orange colorscale indicates the Relative BOL performance where orange indicates higher relative performance and black indicates lower relative performance. FIGS. 2A & 2B depict material combinations that have a moderately high BOL activity, defined as ≥75% of the BOL activity of pure IrOₓ, FIGS. 3A & 3B depict material combinations that have a high BOL activity, defined as ≥100% of the BOL activity of pure IrOₓ, and FIGS. 4A & 4B depict material combinations that have the highest BOL activity, defined as ≥125% of the BOL activity of pure IrOₓ. The data presented in FIGS. 2A&B, 3A&B, and 4A&B is summarized in Tables 1, 2, and 3, respectively, wherein the ranges of compositions that have moderately high, high, and highest BOL activities are summarized in Tables 1, 2, and 3, respectively, as well as the specific material and material performance near to the extent of each range.

Referring to FIGS. 5A-7B, a depiction of End of Life (EOL) activity of samples is shown indicating the level of activity of given ratios according to shading or coloring, for figures A & B respectively, as indicated in the corresponding range bar. The EOL level of activity is illustratively embodied as the activity toward acidic oxygen evolution reaction (OER) of electrocatalysts composed of one, two, or three elements mixed at a given ratio from the Ir—Ru—Mo material space defined by the triangular shape. The triangle represents a specific compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the activity of IrOₓ, a value>1 is more active than IrOₓ, and a value<1 is less active than IrOₓ. In FIGS. 5A, 6A, and 7A, the black and white colorscale indicate the Relative EOL performance where white indicates higher relative performance and black indicates lower relative performance. In FIGS. 5B, 6B, and 7B, the black to orange colorscale indicate the Relative EOL performance where orange indicates higher relative performance and black indicates lower relative performance. FIGS. 5A&B depict material combinations that have a moderately high EOL activity, defined as ≥75% of the EOL activity of pure IrOₓ, FIGS. 6A&B depict material combinations that have a high EOL activity, defined as ≥100% of the EOL activity of pure IrOₓ, and FIGS. 7A&B depict material combinations that have higher EOL activity, defined as ≥125% of the EOL activity of pure IrOₓ. The data presented in FIGS. 5A&B, 6A&B, and 7A&B is summarized in Tables 4, 5, and 6, wherein the ranges of compositions that have moderately high, high, and higher EOL activities are summarized in Table 4, 5, and 6, respectively, as well as the specific material and material performance near the extent of each range.

The EOL activity was measured after the materials were subjected to accelerated stress testing (AST) conditions. Although in the illustrative embodiment, the AST protocol applied chronoamperometry at an oxidative potential in acidic electrolyte for a set period of time, in some embodiments, any suitable AST protocol may be applied (e.g., chronopotentiometry, potential/current pulsing, square-wave voltammetry, cyclic voltammetry, etc.). Each measurement was benchmarked against pure IrOₓ synthesized and measured in the same batch of samples.

Referring now to FIGS. 8A-10B, a depiction of stability of samples is shown indicating the level of activity of given ratios according to shading or coloring, for figures A & B respectively, as indicated in the corresponding range bar. The stability is illustratively embodied as the activity toward acidic oxygen evolution reaction (OER) of electrocatalysts composed of one, two, or three elements mixed at a given ratio from the Ir—Ru—Mo material space defined by the triangular shape. The triangle represents a specific compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the stability of IrOₓ, a value>1 is more stable than IrOₓ, and a value<1 is less stable than IrOₓ. FIGS. 8A&B depict material combinations that have a moderately high stability, defined as ≥75% of the stability of pure IrOₓ, FIGS. 9A&B depict material combinations that have a high stability, defined as ≥100% of the stability of pure IrOₓ, and FIGS. 10A&B depict material combinations that have higher stability, defined as ≥125% of the stability of pure IrOₓ. The data presented in FIGS. 8A&B, 9A&B, and 10A&B is summarized in Tables 7, 8, and 9, respectively, wherein the ranges of compositions that have moderately high, high, and higher stability are summarized in Table 7, 8, and 9, respectively, as well as the specific material and material performance near the extent of each range.

Referring now to FIG. 11, a depiction of a standard powder x-ray diffraction (PXRD) pattern obtained from a representative sample of the novel catalyst. PXRD is a powerful analytical technique used to identify the crystalline phases of a material, based on unique combinations of identifying peaks. In other embodiments, other characterization techniques can be used to determine the crystallographic phases of a material. Peak position for PXRD spectra is dependent on radiation source. A copper source is used in the present embodiment. In other embodiments, other radiation sources may be used. The specific composition of this particular sample is Ir_{0.14}Ru_{0.70}Mo_{0.17}, represented as the molar ratio of the three metal components. The peaks present in this example spectrum have been analyzed and indexed to the space group P6₃/mmc. These data correspond to the sample listed in Table 15 Row 3.

Referring now to FIG. 12, a depiction of the compositional profile of a representative sample of the novel catalyst, expressed as wt %, as measured by scanning electron microscopy coupled with energy-dispersive x-ray spectroscopy (SEM-EDS). SEM-EDS is a coupled analytical technique that yields simultaneous information about the structure and chemical composition of a sample and is used in this embodiment. In other embodiments, other techniques or combinations of techniques can also be used to gain structure and chemical composition of catalyst materials. In the present embodiment, SEM-EDS is used in an automated fashion to collect data from hundreds of features to produce a compositional ternary plot such as the example (wt %). The specific composition of this particular sample is Ir_{0.14}Ru_{0.70}Mo_{0.17}, represented as the molar ratio of the three metal components. These data correspond to the sample listed in Table 15 Row 3.

Referring now to FIGS. 13-15, a collection of depictions of the compositional distribution of the catalyst sample represented by the ternary plot in FIG. 12. Specifically, FIG. 13 is a histogram that depicts the distribution of Ir across hundreds of features in the catalyst sample (wt %). FIG. 14 is a histogram that depicts the distribution of Ru across hundreds of features in the catalyst sample (wt %). FIG. 15 is a histogram that depicts the distribution of Mo across hundreds of features in the catalyst sample (wt %). The overall composition of this particular sample as a molar ratio is Ir_{0.14}Ru_{0.70}W_{0.17}. These data correspond to the sample listed in Table 15 Row 3.

Referring now to FIG. 16, a depiction of the morphological profile of a representative sample of the novel catalyst, expressed the effective circular diameter (ECD) in μm, as measured by scanning electron microscopy (SEM). ECD is a method for expressing the size of features from images such as those gathered by SEM. In any given image, the area of an irregular object in frame can be used to calculate the diameter of a theoretical circle of the same area, this value being the ECD (μm). In the present embodiment, SEM is used in an automated fashion to collect data from hundreds of features to produce a structural ternary plot such as the example. These data correspond to the sample listed in Table 15 Row 3.

Referring now to FIG. 17, a depiction of novel catalyst PEM electrolyzer performance, where the beginning of life (BOL activity) is reported as A/cm² at 2 V vs RHE on a linear polarization curve. The plot depicts the-PEM electrolyzer BOL and EOL (post-1000 hours accelerated stress testing) activity of a Ir_{0.14}Ru_{0.70}Mo_{0.17} sample on a Nafion 115 ionomer membrane. The sample is compared against the BOL activity of an internal pure Ir benchmark on a Nafion N115 ionomer membrane. These data correspond to the sample listed in Table 15 Row 3.

Referring now to FIG. 18, a depiction novel catalyst PEM electrolyzer performance, where the degradation rate is evaluated as percentage of the BOL current density lost per hour of test. Durations are reported in hours. The dark teal line depicts the degradation of the. Ir_{0.14}Ru_{0.70}Mo_{0.17} sample on a Nafion 115 ionomer membrane at 1.7 V vs RHE. The orange line depicts the degradation of the Ir_{0.14}Ru_{0.70}Mo_{0.17} sample on a Nafion 115 ionomer membrane at 2.0 V vs RHE. These data correspond to the sample listed in Table 15 Row 3.

### The Use of Novel Catalyst for Oxygen Evolution in Other Industrial Electrochemical Processes.

Anodes for oxygen evolution are widely used in different industrial electrolysis applications, several of which pertain to the field of electrometallurgy, covering a wide range in terms of applied current density, which can be very low (for instance, a few hundred A/m such as the case of electrowinning processes) or also very high (for instance in high-speed electroplating, which can operate in excess of 10 kA/m referred to the anodic surface). Another field of application of oxygen-evolving anodes is cathodic protection under impressed current.

An anode formulation suitable for anodic oxygen evolution in many traditional industrial electrochemical processes comprises a titanium substrate and a catalytic coating consisting of oxides of iridium and tantalum with a molar composition referred to the metals of 60-70% Ir and 30-40% Ta. In some cases (for instance to be able to operate with very acidic or otherwise corrosive electrolytes), it can be advantageous to interpose an intermediate protective layer between titanium substrate and catalytic coating. For example, such a layer may include titanium and tantalum oxides with molar composition of 80% Ti and 20% Ta referred to the metals. This type of electrode can be prepared in different ways, for example, by thermal decomposition of precursor solution at high temperature, for instance 400° C. to 600° C. For a mixed element electrocatalyst, these preparation methods may lead to a multiphase catalytic coating. In many of these applications, the specific loading of iridium in the catalytic layer exceeds 0.5 mg/cm², often reaching 5 mg/cm², which is up to 10 times higher than the loading used in PEM electrolysis.

Electrodes with a composition in the specified preferred range can satisfy the needs of several industrial applications, both at low and at high current density, with reasonable operative lifetimes. The economy of some manufacturing processes, especially in the field of metallurgy (for instance copper deposition in galvanic processes for the production of printed circuits and copper foil) nevertheless can require electrodes of increasingly high duration, combined with a suitably reduced oxygen evolution potential even at higher current density. The potential of oxygen evolution can, in fact, be one of the main factors in determining the process operative voltage, and thus, the overall energy consumption.

Moreover, the operative lifetime of anodes cased on noble metals or oxides thereof on metal substrates can be remarkable reduced in the presence of particularly aggressive contaminants, which can establish accelerated phenomena of corrosion or of anode surface pollution. It has, therefore, been evidenced the need for oxygen-evolving anodes characterized by a low oxygen evolution overpotential and by higher operative lifetimes even in particularly critical process conditions, such as a high current density and/or the presence of particularly aggressive electrolytes, for instance, due to the presence of contaminant species, and low or no dependence on Ir.

Anodes for oxygen evolution can be accelerated stress tested by, for example, subjecting the electrodes to constant current density of 3 A/cm² in 1-1.5 M H₂SO₄ at a temperature of 60° C. and measuring the deactivation time (the operating time required to observe a potential increase of, for example, 1 V).

Similarities in the harshness of the operating conditions suggest that the low-Ir oxygen evolving catalysts which were discovered could replace or reduce Ir not only in PEM water electrolysis, but also other industrial electrochemical applications as suggested above.

Although the above listed materials were discovered as promising electrocatalysts alternative to IrOₓ specifically for the acidic OER, the compositions of the present invention, including each of the preferred embodiments, can also be used in other applications, such as:

### Electrode Coatings for Electrodeposition Process

Electrodeposition is a well-established industrial tool, particularly in electrometallurgy, for the controllable extraction and plating of metals and alloys. The quality of electrodeposited films, including adhesion and uniformity, is highly dependent on harsh operating conditions, such as current density, pH, and temperature, in addition to the local morphology of the electrode. IrOₓ has been employed as an electrode material in some industrial electrodeposition processes, due to its durability. Electrodes fabricated from the disclosed novel electrocatalyst can be used in electrodeposition processes in place of IrOₓ or other noble/transition/platinum group metals where appropriate

### Electrode Coatings for Electrowinning

Electrowinning is the electrodeposition of metals from an ore leach solution containing metal ions. It is important for the industrial purification of metals and can involve harsh conditions, such as high current density and temperature, as well as low pH. IrOₓ has been employed as an electrode material in some industrial electrowinning processes due to its durability. Electrodes fabricated from the disclosed novel electrocatalyst can be used in electrowinning processes in place of IrOₓ or other noble/transition/platinum group metals where appropriate.

### Electrode Coatings for Electroplating

Electroplating is a well-established industrial tool, particularly in electrometallurgy, for the controllable extraction and plating of metals and alloys. The quality of electroplated films, including adhesion and uniformity, is highly dependent on potentially harsh operating conditions, such as high current density and temperature, along with low pH. IrOₓ has been employed as an electrode material in some industrial electroplating processes, due to its durability. Electrodes fabricated from the disclosed novel electrocatalyst can be used in electroplating processes in place of IrOₓ or other noble/transition/platinum group metals where appropriate.

### Electrode Coatings for Chlorine Production

The chlorine evolution reaction (CER) is a critical anodic reaction in chlor-alkali electrolysis and is utilized at industrial scales. Typically, pure noble metal electrocatalysts are used. Operation of the reaction can occur in both neutral and acidic pH, but both are prone to competing side reactions, such as the oxygen evolution reaction (OER). Including other elements, such as those included in the disclosed novel catalyst, can help mitigate these factors. Electrodes fabricated from the disclosed novel electrocatalyst can be utilized for CER and other halogen generating applications in place of IrOₓ or other noble/transition/platinum group metals where appropriate.

### Electrocatalysts for Hydrogen Generation and Oxidation

The hydrogen evolution reaction (HER) and the hydrogen oxidation reaction (HOR) are critical to the future of hydrogen fuel. HOR rate is hindered under alkaline conditions. Therefore, the reaction is typically performed under acidic conditions and requires the use of robust and scarce IrOₓ. Electrodes fabricated from the disclosed novel electrocatalyst can be utilized for HER/HOR applications in place of IrOₓ or other noble/transition/platinum group metals where appropriate.

### Electrocatalysts for Oxygen Generation and Reduction

The oxygen evolution reaction (OER) and the oxygen reduction reaction (ORR) are core steps of many systems for energy conversion and storage but are prone to sluggish kinetics and multielectron transfer processes. Platinum and other platinum group metal (PGM) based materials are typically employed for OER/ORR. Electrodes fabricated from the disclosed novel electrocatalyst can be utilized for OER/ORR applications in place of IrOₓ or other noble/transition/platinum group metals where appropriate.

### Electrocatalysts for CO₂ Conversion

The electrocatalytic conversion of CO₂ is one potential approach to lessen anthropogenic contributions to atmospheric CO₂ and store excess renewable electricity as chemical energy in fuels. Various noble and transition metal catalysts have been developed for electrocatalytic CO₂ conversion, but it can be hindered by poor energy efficiency, reaction selectivity, and overall conversion rate. Electrodes fabricated from the disclosed novel electrocatalyst may be applied for electrocatalytic CO₂ conversion reactions in place of noble/transition/platinum group metals where appropriate.

### Electrocatalysts for Biomass Conversion

Selective and efficient electrochemical conversion of biomass derivatives can provide an economically viable and scalable approach to storing renewable energy. Both biomass conversion and OER involve nucleophilic reactions. Therefore, the selection of materials for biomass conversion is primarily based on effective OER electrocatalysts such as IrO₂ and others. Electrodes fabricated from the disclosed novel electrocatalyst may be applied for electrocatalytic biomass conversion reactions in place of noble/transition/platinum group metals where appropriate.

### Catalysts for Hydrogenation and De-Hydrogenation

Electrocatalytic hydrogenation (ECH) and dehydrogenation reactions produce high value chemicals from organic feedstocks and water. These reactions can be limited by the low solubility of reagents in aqueous conditions and electrical losses in organic conditions. Generally, noble and platinum group metals are employed for these reactions. Electrodes fabricated from the disclosed novel electrocatalyst may be applied for electrocatalytic hydrogenation/dehydrogenation reactions in place of noble/transition/platinum group metals where appropriate.

### Catalysts for Ammonia Generation and Conversion

Ammonia is a fundamental chemical used in many industrial applications and has historically been generated by CO₂ emitting processes. The development of electrocatalytic generation of clean ammonia enables a route to decentralized ammonia production at room temperature from local renewable energy. Nitrate reduction reaction (NRR) produces ammonia from nitrate ions, abundantly found in polluted groundwater and industrial wastewater, using noble metal based catalysts. Electrodes fabricated from the disclosed novel electrocatalyst may be applied for electrocatalytic ammonia generation and conversion reactions in place of noble/transition/platinum group metals where appropriate.

### Catalysts for Gas Purification, Among Others Dexoygenation, Dehydrogenation, CO₂ Cleaning

Electrocatalytic reactions like those described above, among others, can be employed for gas purification. For instance, H₂ streams generated from OER typically contain O₂ at unsafe levels. Platinum group metal electrocatalysts can be employed to remove O₂ selectively from H₂ streams. Additionally, flue gas produced from industrial combustion can contain significant amounts of CO₂ and is a target for capture and utilization. However, the gas also contains notable impurities, such as SO₂, that can poison the active sites of ideal electrocatalysts. Electrodes fabricated from the disclosed novel electrocatalyst may be applied for electrocatalytic gas purification reactions in place of noble/transition/platinum group metals where appropriate.

### Electrocatalysts for Organic Oxidation Reactions

Electrooxidation of organic compounds can leverage local green electricity to produce high value chemicals from organic feedstocks and water. These reactions have been limited by the lack of stable and efficient electrocatalyst materials. Electrodes fabricated from the disclosed novel electrocatalyst may be applied for electrocatalytic hydrogenation/dehydrogenation reactions in place of noble/transition/platinum group metals where appropriate.

The tables provided herein after include:

TABLE 1 shows ranges for preferred catalyst material sample combinations based on moderately high Beginning of Life (BOL) activity relative to the IrOₓ standard according to illustrative embodiments. The columns listed as Upper Relative BOL Activity at Min at % show the highest Relative Beginning of Life (BOL) activity at the lowest compositional value in the range for each element. The columns listed as Upper Relative BOL Activity at Max show the highest Relative BOL activity at the highest compositional value in the range for each element. Referring to values in Table 1, Row 1 as an example: The compositional range is 2-91 at % for Iridium, 2-90 at % for Ruthenium, and 2-86 at % for Molybdenum. The Upper BOL Activity at Min Ir at % value of 1.0261 is the highest Relative BOL activity for materials with 2% Iridium. The Upper Relative BOL Activity at Max Ir at % value of 1.5437 is the highest Relative BOL activity for materials with 91% Iridium. The Upper Relative BOL Activity at Min Ru at % value of 1.5437 is the highest Relative BOL activity for materials with 2% Ruthenium. The Upper Relative BOL Activity at Max Ru at % value of 1.1248 is the highest Relative BOL activity for materials with 90 at % Ruthenium. The Upper Relative BOL Activity at Min Mo at % value of 1.0269 is the highest Relative BOL activity for materials with 2% Molybdenum. The Upper Relative BOL Activity at Max Mo at % value of 0.8868 is the highest Relative BOL activity for materials with 86% Molybdenum. Higher values indicate better Relative BOL activity. BOL is measured via chronoamperometry as current generated by the catalyst when subjected, for example, to constant voltage of 2 V versus reversible hydrogen electrode (RHE) in 0.3 M HClO₄ normalized to an IrOₓ standard. The preferred ranges of Ir—Ru—Mo relative to each other to achieve moderately high beginning of life (BOL) activity are Ir (2-91 at %), Ru (2-90 at %), and Mo (2-86 at %). For Ir—Mo, the preferred ranges to achieve moderately high BOL are Ir (51-96 at %) and Mo (4-49 at %). For Ru—Mo, the preferred ranges to achieve moderately high BOL are Ru (93-94 at %) and Mo (6-7 at %).

TABLE 2 shows ranges for more preferred catalyst material sample combinations based on high Beginning of Life (BOL) activity relative to the IrOₓ standard according to illustrative embodiments. The preferred ranges of Ir—Ru—Mo relative to each other to achieve high beginning of life (BOL) activity are Ir (2-91 at %), Ru (2-90 at %), and Mo (2-80 at %). For Ir—Mo, the preferred ranges to achieve high BOL are Ir (66-96 at %) and Mo (4-34 at %).

TABLE 3 shows ranges for most preferred catalyst material sample combinations based on highest Beginning of Life (BOL) activity relative to the IrOₓ standard according to illustrative embodiments. The preferred ranges of Ir—Ru—Mo relative to each other to achieve the highest beginning of life (BOL) activity are Ir (6-91 at %), Ru (2-86 at %), and Mo (3-57 at %). For Ir—Mo, the preferred ranges to achieve the highest BOL are Ir (78-96 at %) and Mo (4-22 at %).

TABLE 4 is shows ranges for preferred catalyst material sample combinations based on moderately high End of Life (EOL) activity relative to the IrOₓ standard according to illustrative embodiments. The columns listed as Upper Relative EOL Activity at Min at % show the highest Relative End of Life (EOL) activity at the lowest compositional value in the range for each element. The columns listed as Upper Relative EOL Activity at Max at % show the highest Relative EOL activity at the highest compositional value in the range for each element. Referring to values in Table 4, Row 1 as an example: The compositional range is 2-91 at % for Iridium, 2-90 at % for Ruthenium, and 2-86 at % for Molybdenum. The Upper EOL Activity at Min Ir at % value of 0.8133 is the highest Relative EOL activity for materials with 2% Iridium. The Upper Relative EOL Activity at Max Ir at % value of 1.4226 is the highest Relative EOL activity for materials with 91% Iridium. The Upper Relative EOL Activity at Min Ru at % value of 1.4226 is the highest Relative EOL activity for materials with 2% Ruthenium. The Upper Relative EOL Activity at Max Ru at % value of 0.8798 is the highest Relative EOL activity for materials with 90 at % Ruthenium. The Upper Relative EOL Activity at Min Mo at % value of 0.843 is the highest Relative EOL activity for materials with 2% Molybdenum. The Upper Relative EOL Activity at Max Mo at % value of 0.8606 is the highest Relative EOL activity for materials with 86% Molybdenum. Higher values indicate better Relative EOL activity. The end of EOL activity of catalysts toward acidic oxygen evolution reaction (OER) was measured via chronoamperometry as current generated by the catalyst when subjected to constant voltage of 2 V versus reversible hydrogen electrode (RHE) in 0.3 M HClO₄, normalized to an IrOₓ standard, after accelerated stress testing (AST) of the catalysts. The preferred ranges of Ir—Ru—Mo relative to each other to achieve moderately high end of life (EOL) activity are Ir (2-91 at %), Ru (2-90 at %), and Mo (2-86 at %). For Ir—Mo, the preferred ranges to achieve moderately high EOL are Ir (50-96 at %) and Mo (4-34 at %).

TABLE 5 is shows ranges for more preferred catalyst material sample combinations based on high End of Life (EOL) activity relative to the IrOₓ standard according to illustrative embodiments. The preferred ranges of Ir—Ru—Mo relative to each other to achieve high end of life (EOL) activity are Ir (6-91 at %), Ru (2-71 at %), and Mo (3-79 at %). For Ir—Mo, the preferred ranges to achieve high EOL are Ir (66-96 at %) and Mo (4-34 at %).

TABLE 6 shows ranges for even more preferred catalyst material sample combinations based on the highest End of Life (EOL) activity relative to the IrOₓ standard according to illustrative embodiments. The preferred ranges of Ir—Ru—Mo relative to each other to achieve the highest end of life (EOL) activity are Ir (84-91 at %), Ru (2-7 at %), and Mo (4-13 at %). For Ir—Mo, the preferred ranges to achieve the highest EOL are Ir (77-96 at %) and Mo (4-23 at %).

TABLE 7 shows ranges for preferred catalyst material sample combinations based on moderately high stability relative to the IrOₓ standard according to illustrative embodiments. The columns listed as Upper Relative Stability at Min at % show the best Relative Stability at the lowest compositional value in the range for each element. The columns listed as Upper Relative Stability at Max at % show the best Relative Stability at the highest compositional value in the range for each element. Referring to values in Table 7, Row 1 as an example: The compositional range is 7-87 at % for Iridium, 3-27 at % for Ruthenium, and 10-86 at % for Molybdenum. The Upper Relative Stability at Min Ir at % value of 1.1063 is the highest Relative Stability for materials with 7% Iridium. The Upper Relative Stability at Max Ir at % value of 1.3171 is the highest Relative Stability for materials with 87% Iridium. The Upper Relative Stability at Min Ru at % value of 0.9256 is the highest Relative Stability for materials with 3% Ruthenium. The Upper Relative Stability at Max Ru at % value of 1.3103 is the highest Relative Stability for materials with 27 at % Ruthenium. The Upper Relative Stability at Min Mo at % value of 1.3171 is the highest Relative Stability for materials with 10% Molybdenum. The Upper Relative Stability at Max Mo at % value of 1.1548 is the highest Relative Stability for materials with 86% Molybdenum. Lower values indicate better Relative Stability. Stability is calculated as (EOL_{catalyst}-BOL_{catalyst})/BOL_{catalyst} normalized (EOL_{IrOx}−BOL_{IrOx})/BOL_{IrOx}. The preferred ranges of Ir—Ru—Mo relative to each other to achieve moderately high stability are Ir (7-87 at %), Ru (3-27 at %), and Mo (10-86 at %). For Ir—Mo, the preferred ranges to achieve moderately high stability are Ir (14-92 at %) and Mo (8-86 at %). For Ru—Mo, the preferred ranges to achieve moderately high stability are Ru (14-47 at %) and Mo (53-86 at %).

TABLE 8 shows ranges for more preferred catalyst material sample combinations based on higher stability relative to the IrOₓ standard according to illustrative embodiments. The preferred ranges of Ir—Ru—Mo relative to each other to achieve high stability are Ir (12-83 at %), Ru (3-16 at %), and Mo (14-79 at %). For Ir—Mo, the preferred ranges to achieve high stability are Ir (14-88 at %) and Mo (12-86 at %). For Ru—Mo, the preferred ranges to achieve high stability are Ru (14-36 at %) and Mo (64-86 at %).

TABLE 9 shows ranges for even preferred catalyst material sample combinations based on the highest stability relative to the IrOₓ standard according to illustrative embodiments. The preferred ranges of Ir—Ru—Mo relative to each other to achieve the highest stability are Ir (17-80 at %), Ru (4-11 at %), and Mo (16-75 at %). For Ir—Mo, the preferred ranges to achieve the highest stability are Ir (14-86 at %) and Mo (14-86 at %). For Ru—Mo, the preferred ranges to achieve the highest stability are Ru (14-27 at %) and Mo (73-86 at %).

TABLE 10 shows ranges for preferred catalyst material sample combinations based on moderately high overall performance relative to the IrOₓ standard according to illustrative embodiments. Moderately high overall performance is indicated by a BOL activity≥75% of pure IrOₓ and a stability≥75% of pure IrOₓ. The preferred ranges of Ir—Ru—Mo relative to each other to achieve moderately high overall performance are Ir (6-84 at %), Ru (4-26 at %), and Mo (12-86 at %). For Ir—Mo, the preferred ranges to achieve moderately high overall performance are Ir (52-86 at %) and Mo (14-48 at %).

TABLE 11 shows ranges for more preferred catalyst material sample combinations based on high overall performance relative to the IrOₓ standard according to illustrative embodiments. High overall performance is indicated by a BOL activity≥100% of pure IrOₓ and a stability≥100% of pure IrOₓ. The preferred ranges of Ir—Ru—Mo relative to each other to achieve high overall performance are Ir (12-80 at %), Ru (4-16 at %), and Mo (16-76 at %). For Ir—Mo, the preferred ranges to achieve high overall performance are Ir (68-82 at %) and Mo (18-32 at %).

TABLE 12 is a description of various individual novel catalyst material combinations including samples with moderately high beginning of life (BOL) activity≥75% of pure IrOₓ and a stability≥75% of pure IrOₓ.

TABLE 13 is a description of various individual novel catalyst material combinations including samples with high beginning of life (BOL) activity≥100% of pure IrOₓ and a stability≥100% of pure IrOₓ.

TABLE 14 shows ranges of preferred catalyst material sample combinations based on performance of gram scale samples according to illustrative embodiments. For each constituent element (Ir, Ru, Mo), the minimum (min avg at %) and maximum (max avg at %) composition values encompass the preferred ranges. As used herein, the standard deviation refers to the deviation in molar compositions of individual particles as compared to the average for the sample as a whole. The deviation for these values describes the average deviation for any given feature in a sample. All at % values and deviations are generated from hundreds of features measured by SEM-EDS. Simultaneously, structural information is gathered by SEM as the effective circular diameter (ECD). ECD expresses the size of irregular objects in an image by calculating the diameter of a theoretical circle of the same area as the object. Catalyst powders are loaded onto glassy carbon electrodes and screened for OER activity in three electrode test by linear sweep voltammetry (1.1-1.8 V vs. RHE and reported as μA/μg at 1.8 V vs. RHE) and durability by chronoamperometry (1.65 V vs. RHE for 5-800 minutes and reported as % loss in activity post-hold). Finally, catalysts are applied as an anode material to an ionomer membrane, where the loading is measured as mg/cm² and the membrane resistance is measured in mΩ, and subsequently tested in a PEM electrolyzer station. PEM electrolyzer BOL activity is determined via linear sweep and reported as A/cm² at 2.0 V vs RHE. PEM electrolyzer degradation rates are only reported for catalysts tested under respective accelerated stress testing conditions (i.e. square wave, SqW) for longer than 50 hours.

TABLE 15 is a description of various individual novel catalyst material combinations including samples with PEM electrolyzer performance meeting or exceeding that of the commercial Ir catalyst (Umicore Ir Lot 1029-29/13). For each constituent element (Ir, Ru, Mo), the average at % composition values are reported for individual samples. The deviation for these values describes the average deviation for any given feature in a sample. All at % values and deviations are generated from hundreds of features measured by SEM-EDS. The composition is additionally expressed as a molar ratio with the formula Ir_{X}Ru_{Y}Mo_{Z}, where X+Y+Z=1.0. Structural information is gathered by SEM for each sample as the effective circular diameter (ECD). ECD expresses the size of irregular objects in an image by calculating the diameter of a theoretical circle of the same area as the object. Catalyst powders are loaded onto glassy carbon electrodes and screened for OER activity in three electrode tests by linear sweep voltammetry (1.1-1.8 V vs. RHE and reported as μA/μg at 1.8 V vs. RHE) and durability by chronoamperometry (1.65 V vs. RHE for 5-800 minutes and reported as % loss in activity post-hold). Finally, catalysts are applied as an anode material to an ionomer membrane, where the loading is measured as mg/cm² and the membrane resistance is measured in mΩ, and subsequently tested in a PEM electrolyzer station. PEM electrolyzer BOL activity is determined via linear sweep and reported as A/cm² at 2.0 V vs RHE. PEM electrolyzer degradation rates are only reported for catalysts tested under respective accelerated stress testing conditions (i.e. square wave, SqW) for longer than 50 hours.

TABLE 1
Preferred Catalyst Composition Ranges Based on Moderately High BOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 2 | 91 | 2 | 90 | 2 | 86 |
| 51 | 96 | 0 | 0 | 1 | 49 |
| 0 | 0 | 93 | 94 | 6 | 7 |

| Upper | Upper | Upper | Upper | Upper | Upper |
|---|---|---|---|---|---|
| Iridium | Iridium | Ruthenium | Ruthenium | TMolybdenum | Molybdenum |
| Relative | Relative | Relative | Relative | Relativem | Relative |
| BOL | BOL | BOL | BOL | BOL | BOL |
| Activity @ | Activity @ | Activity @ | Activity @ | Activity @ | Activity @ |
| Min at % | Max at % | Min at % | Max at % | Min at % | Max at % |
| 1.0261 | 1.5437 | 1.5437 | 1.1248 | 1.0269 | 0.8868 |
| 0.7639 | 1.4483 | | | 1.4483 | 0.7639 |
| | | 0.7523 | 0.7548 | 0.7548 | 0.7523 |

TABLE 2
More Preferred Catalyst Composition Ranges Based on High BOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 2 | 91 | 2 | 90 | 2 | 80 |
| 66 | 96 | 0 | 0 | 4 | 34 |

| Upper | Upper | Upper | Upper | Upper | Upper |
|---|---|---|---|---|---|
| Iridium | Iridium | Ruthenium | Ruthenium | TMolybdenum | Molybdenum |
| Relative | Relative | Relative | Relative | Relative | Relative |
| BOL | BOL | BOL | BOL | BOL | BOL |
| Activity @ | Activity @ | Activity @ | Activity @ | Activity @ | Activity @ |
| Min at % | Max at % | Min at % | Max at % | Min at % | Max at % |
| 1.0261 | 1.5437 | 1.5437 | 1.1248 | 1.0269 | 1.0214 |
| 1.0167 | 1.4483 | | | 1.4483 | 1.0167 |

TABLE 3
Most Preferred Catalyst Composition Ranges Based on Highest BOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 6 | 91 | 2 | 86 | 3 | 57 |
| 78 | 96 | 0 | 0 | 4 | 22 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| BOL | BOL | BOL | BOL | BOL | BOL |
| Activity @ | Activity @ | Activity @ | Activity @ | Activity @ | Activity @ |
| Min at % | Max at % | Min at % | Max at % | Min at % | Max at % |
| 1.5255 | 1.5437 | 1.5437 | 1.2674 | 1.3043 | 1.2637 |
| 1.2605 | 1.4483 | | | 1.4483 | 1.2605 |

TABLE 4
Preferred Catalyst Composition Ranges Based on Moderately High EOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 2 | 91 | 2 | 90 | 2 | 86 |
| 50 | 96 | 0 | 0 | 4 | 50 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| EOL | EOL | EOL | EOL | EOL | EOL |
| Activity @ | Activity @ | Activity @ | Activity @ | Activity @ | Activity @ |
| Min at % | Max at % | Min at % | Max at % | Min at % | Max at % |
| 0.8133 | 1.4226 | 1.4226 | 0.8798 | 0.8433 | 0.8606 |
| 0.7605 | 1.3223 | | | 1.3223 | 0.7605 |

TABLE 5
More Preferred Catalyst Composition Ranges Based on High EOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 6 | 91 | 2 | 71 | 3 | 79 |
| 66 | 96 | 0 | 0 | 4 | 34 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| EOL | EOL | EOL | EOL | EOL | EOL |
| Activity @ | Activity @ | Activity @ | Activity @ | Activity @ | Activity @ |
| Min at % | Max at % | Min at % | Max at % | Min at % | Max at % |
| 1.1192 | 1.4226 | 1.4226 | 1.0015 | 1.0211 | 1.0057 |
| 1.0127 | 1.3223 | | | 1.3223 | 1.0127 |

TABLE 6
Most Preferred Catalyst Composition Ranges Based on Highest EOL Activity

| Iridium | Iridium | Ruthenium | Ruthenium | Molybdenum | Molybdenum |
|---|---|---|---|---|---|
| Min at % | Max at % | Min at % | Max at % | Min at % | Max at % |
| 84 | 91 | 2 | 7 | 4 | 13 |
| 77 | 96 | 0 | 0 | 4 | 23 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| EOL | EOL | EOL | EOL | EOL | EOL |
| Activity @ | Activity @ | Activity @ | Activity @ | Activity @ | Activity @ |
| Min at % | Max at % | Min at % | Max at % | Min at % | Max at % |
| 1.2532 | 1.4226 | 1.4226 | 1.2985 | 1.2985 | 1.2532 |
| 1.2592 | 1.3223 | | | 1.3223 | 1.2592 |

TABLE 7
Preferred Catalyst Composition Ranges Based on Moderately High Stability

| Iridium | Iridium | Ruthenium | Ruthenium | Molybdenum | Molybdenum |
|---|---|---|---|---|---|
| Min at % | Max at % | Min at % | Max at % | Min at % | Max at % |
| 7 | 87 | 3 | 27 | 10 | 86 |
| 14 | 92 | 0 | 0 | 8 | 86 |
| 0 | 0 | 14 | 47 | 53 | 86 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| Stability @ | Stability @ | Stability @ | Stability @ | Stability @ | Stability @ |
| Min at % | Max at % | Min at % | Max at % | Min at % | Max at % |
| 1.1063 | 1.3171 | 0.9256 | 1.3103 | 1.3171 | 1.1548 |
| −0.1906 | 1.3311 | | | 1.3311 | −0.9256 |
| | | 0.4579 | 1.3191 | 1.3191 | 0.4579 |

TABLE 8
More Preferred Catalyst Composition Ranges Based on High Stability

| Iridium | Iridium | Ruthenium | Ruthenium | Molybdenum | Molybdenum |
|---|---|---|---|---|---|
| Min at % | Max at % | Min at % | Max at % | Min at % | Max at % |
| 12 | 83 | 3 | 16 | 14 | 79 |
| 14 | 88 | 0 | 0 | 12 | 86 |
| 0 | 0 | 14 | 36 | 64 | 86 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| Stability @ | Stability @ | Stability @ | Stability @ | Stability @ | Stability @ |
| Min at % | Max at % | Min at % | Max at % | Min at % | Max at % |
| 0.9838 | 0.9256 | 0.9256 | 0.9722 | 0.9256 | 0.9577 |
| −0.1906 | 0.9802 | | | 0.9802 | −0.1906 |
| | | 0.4579 | 0.9819 | 0.9819 | 0.4579 |

TABLE 9
Most Preferred Catalyst Composition Ranges Based on Highest Stability

| Iridium | Iridium | Ruthenium | Ruthenium | Molybdenum | Molybdenum |
|---|---|---|---|---|---|
| Min at % | Max at % | Min at % | Max at % | Min at % | Max at % |
| 17 | 80 | 4 | 11 | 16 | 75 |
| 14 | 86 | 0 | 0 | 14 | 86 |
| 0 | 0 | 14 | 27 | 73 | 86 |

| Upper | Upper | Upper | Upper | Upper | Upper |
|---|---|---|---|---|---|
| Iridium | Iridium | Ruthenium | Ruthenium | Molybdenum | Molybdenum |
| Relative | Relative | Relative | Relative | Relative | Relative |
| Stability @ | Stability @ | Stability @ | Stability @ | Stability @ | Stability @ |
| Min at % | Max at % | Min at % | Max at % | Min at % | Max at % |
| 0.7649 | 0.7547 | 0.3963 | 0.7789 | 0.7547 | 0.7649 |
| −0.1906 | 0.7818 | | | 0.7818 | −0.1906 |
| | | 0.4579 | 0.7846 | 0.7846 | 0.4579 |

TABLE 10
Preferred Catalyst Composition Ranges Based
on Moderately High Overall Performance

| | | | | | | Iridium |
|---|---|---|---|---|---|---|
| | | | | | | Relative BOL |
| Iridium | Iridium | Ruthenium | Ruthenium | Molybdenum | Molybdenum | Activity @ |
| Min % | Max % | Min % | Max % | Min % | Max % | Min % |
| 6 | 84 | 4 | 26 | 12 | 86 | 0.9727 |
| 52 | 86 | 0 | 0 | 14 | 48 | 0.7815 |

| Iridium | Ruthenium | Ruthenium | Molybdenum | Molybdenum |
|---|---|---|---|---|
| Relative BOL | Relative BOL | Relative BOL | Relative BOL | Relative BOL |
| Activity @ | Activity @ | Activity @ | Activity @ | Activity @ |
| Max % | Min % | Max % | Min % | Max % |
| 1.3006 | 1.3006 | 1.0745 | 1.3006 | 0.8868 |
| 1.4341 | | | 1.4341 | 0.7815 |

TABLE 11
More Preferred Catalyst Composition Ranges Based on Higher Overall Performance

| | | | | | | Upper |
|---|---|---|---|---|---|---|
| | | | | | | Iridium |
| | | | | | | Relative BOL |
| Iridium | Iridium | Ruthenium | Ruthenium | Molybdenum | Molybdenum | Activity @ |
| Min % | Max % | Min % | Max % | Min % | Max % | Min % |
| 12 | 80 | 4 | 16 | 16 | 76 | 1.0093 |
| 68 | 82 | 0 | 0 | 18 | 32 | 1.0464 |

| Upper | Upper | Upper | Upper | Upper |
|---|---|---|---|---|
| Iridium | Ruthenium | Ruthenium | Molybdenum | Molybdenum |
| Relative BOL | Relative BOL | Relative BOL | Relative BOL | Relative BOL |
| Activity @ | Activity @ | Activity @ | Activity @ | Activity @ |
| Max % | Min % | Max % | Min % | Max % |
| 1.0013 | 1.0013 | 1.0301 | 1.0013 | 1.0093 |
| 1.2822 | | | 1.2822 | 1.0464 |

TABLE 12
Data for moderately high overall performance on chip

| Iridium | Ruthenium | Molybdenum | Ratio | Relative | Relative | Relative |
|---|---|---|---|---|---|---|
| Composition | Composition | Composition | IrₓRu_{y}Mo_{z} | BOL | EOL | Stability |
| 86 | 0 | 14 | Ir_{0.86}Ru_{0.0}Mo_{0.14} | 1.4482 | 1.5405 | 0.6662 |
| 84 | 0 | 16 | Ir_{0.84}Ru_{0.0}Mo_{0.16} | 1.3576 | 1.3501 | 1.0047 |
| 84 | 4 | 12 | Ir_{0.84}Ru_{0.04}Mo_{0.312} | 1.3006 | 1.2441 | 1.2271 |
| 82 | 0 | 18 | Ir_{0.82}Ru_{0.0}Mo_{0.18} | 1.2822 | 1.3118 | 0.8486 |
| 80 | 0 | 20 | Ir_{0.80}Ru_{0.0}Mo_{0.20} | 1.2304 | 1.2859 | 0.7324 |
| 78 | 0 | 22 | Ir_{0.78}Ru_{0.0}Mo_{0.22} | 1.1985 | 1.2685 | 0.6672 |
| 76 | 0 | 24 | Ir_{0.76}Ru_{0.0}Mo_{0.24} | 1.1674 | 1.2322 | 0.6885 |
| 82 | 4 | 14 | Ir_{0.82}Ru_{0.04}Mo_{0.14} | 1.1574 | 1.1556 | 1.0100 |
| 74 | 0 | 26 | Ir_{0.74}Ru_{0.0}Mo_{0.26} | 1.1394 | 1.1911 | 0.7472 |
| 72 | 0 | 28 | Ir_{0.72}Ru_{0.0}Mo_{0.28} | 1.051 | 1.1505 | 0.7705 |
| 10 | 24 | 66 | Ir_{0.60}Ru_{0.16}Mo_{0.24} | 1.1044 | 1.0342 | 1.3333 |
| 8 | 24 | 68 | Ir_{0.08}Ru_{0.24}Mo_{0.68} | 1.1037 | 1.0338 | 1.3325 |
| 8 | 22 | 70 | Ir_{0.84}Ru_{0.22}Mo_{0.70} | 1.0985 | 1.0309 | 1.3229 |
| 12 | 24 | 64 | Ir_{0.12}Ru_{0.24}Mo_{0.64} | 1.0962 | 1.0301 | 1.3163 |
| 10 | 22 | 68 | Ir_{0.10}Ru_{0.22}Mo_{0.68} | 1.0930 | 1.0306 | 1.2992 |
| 14 | 24 | 62 | Ir_{0.14}Ru_{0.24}Mo_{0.62} | 1.0870 | 1.0240 | 1.3041 |
| 12 | 22 | 66 | Ir_{0.12}Ru_{0.22}Mo_{0.66} | 1.0863 | 1.0289 | 1.2771 |
| 10 | 20 | 70 | Ir_{0.10}Ru_{0.20}Mo_{0.70} | 1.0813 | 1.0297 | 1.2502 |
| 8 | 20 | 72 | Ir_{0.42}Ru_{0.36}Mo_{0.22} | 1.0794 | 1.0281 | 1.2491 |
| 80 | 6 | 14 | Ir_{0.50}Ru_{0.04}Mo_{0.46} | 1.0789 | 1.0270 | 1.2524 |
| 14 | 22 | 64 | Ir_{0.34}Ru_{0.30}Mo_{0.36} | 1.0782 | 1.0261 | 1.2536 |
| 12 | 20 | 68 | Ir_{0.12}Ru_{0.20}Mo_{0.68} | 1.0765 | 1.0316 | 1.2188 |
| 8 | 18 | 74 | Ir_{0.08}Ru_{0.18}Mo_{0.74} | 1.0757 | 1.0260 | 1.2423 |
| 70 | 0 | 30 | Ir_{0.70}Ru_{0.0}Mo_{0.30} | 1.0753 | 1.1079 | 0.8324 |
| 18 | 26 | 56 | Ir_{0.18}Ru_{0.26}Mo_{0.56} | 1.0745 | 1.0122 | 1.3046 |
| 16 | 24 | 60 | Ir_{0.16}Ru_{0.24}Mo_{0.60} | 1.0730 | 1.0165 | 1.2754 |
| 14 | 66 | 20 | Ir_{0.14}Ru_{0.66}Mo_{0.20} | 1.0704 | 1.0320 | 1.1883 |
| 10 | 18 | 72 | Ir_{0.10}Ru_{0.18}Mo_{0.72} | 1.0702 | 1.0281 | 1.2063 |
| 12 | 18 | 70 | Ir_{0.12}Ru_{0.18}Mo_{0.70} | 1.0654 | 1.0309 | 1.1699 |
| 16 | 22 | 62 | Ir_{0.16}Ru_{0.22}Mo_{0.62} | 1.0644 | 1.0202 | 1.2180 |
| 8 | 16 | 76 | Ir_{0.08}Ru_{0.16}Mo_{0.76} | 1.0636 | 1.0337 | 1.1471 |
| 10 | 16 | 74 | Ir_{0.10}Ru_{0.16}Mo_{0.74} | 1.0624 | 1.0317 | 1.1514 |
| 14 | 18 | 68 | Ir_{0.14}Ru_{0.18}Mo_{0.68} | 1.0602 | 1.0351 | 1.1238 |
| 18 | 24 | 58 | Ir_{0.18}Ru_{0.24}Mo_{0.58} | 1.0594 | 1.0103 | 1.2427 |
| 16 | 20 | 64 | Ir_{0.16}Ru_{0.20}Mo_{0.64} | 1.0582 | 1.0268 | 1.1548 |
| 20 | 26 | 54 | Ir_{0.20}Ru_{0.26}Mo_{0.54} | 1.0544 | 0.9970 | 1.2855 |
| 12 | 16 | 72 | Ir_{0.12}Ru_{0.16}Mo_{0.72} | 1.0538 | 1.0331 | 1.1024 |
| 8 | 14 | 78 | Ir_{0.34}Ru_{0.28}Mo_{0.38} | 1.0522 | 1.0275 | 1.1231 |
| 16 | 18 | 66 | Ir_{0.36}Ru_{0.30}Mo_{0.34} | 1.0507 | 1.0361 | 1.0729 |
| 18 | 22 | 60 | Ir_{0.48}Ru_{0.04}Mo_{0.48} | 1.0485 | 1.0121 | 1.1823 |
| 14 | 16 | 70 | Ir_{0.14}Ru_{0.16}Mo_{0.70} | 1.0468 | 1.0363 | 1.0519 |
| 10 | 14 | 76 | Ir_{0.10}Ru_{0.14}Mo_{0.76} | 1.0468 | 1.0314 | 1.0771 |
| 68 | 0 | 32 | Ir_{0.68}Ru_{0.0}Mo_{0.32} | 1.0464 | 1.0621 | 0.9185 |
| 18 | 20 | 62 | Ir_{0.18}Ru_{0.20}Mo_{0.62} | 1.0462 | 1.0176 | 1.1258 |
| 16 | 16 | 68 | Ir_{0.16}Ru_{0.16}Mo_{0.68} | 1.0387 | 1.0378 | 1.0035 |
| 18 | 18 | 64 | Ir_{0.18}Ru_{0.18}Mo_{0.64} | 1.0381 | 1.0267 | 1.0576 |
| 12 | 14 | 74 | Ir_{0.12}Ru_{0.14}Mo_{0.74} | 1.0380 | 1.0310 | 1.0356 |
| 20 | 24 | 56 | Ir_{0.20}Ru_{0.24}Mo_{0.56} | 1.0316 | 0.9839 | 1.2424 |
| 18 | 16 | 66 | Ir_{0.18}Ru_{0.16}Mo_{0.66} | 1.0301 | 1.0354 | 0.9729 |
| 14 | 14 | 72 | Ir_{0.14}Ru_{0.14}Mo_{0.72} | 1.0269 | 1.0300 | 0.9840 |
| 20 | 22 | 58 | Ir_{0.20}Ru_{0.22}Mo_{0.58} | 1.0242 | 0.9892 | 1.1790 |
| 20 | 18 | 62 | Ir_{0.20}Ru_{0.18}Mo_{0.62} | 1.0177 | 1.0044 | 1.0685 |
| 66 | 0 | 34 | Ir_{0.66}Ru_{0.0}Mo_{0.34} | 1.0167 | 1.0127 | 1.0206 |
| 20 | 20 | 60 | Ir_{0.20}Ru_{0.20}Mo_{0.60} | 1.0148 | 0.9881 | 1.1376 |
| 16 | 14 | 70 | Ir_{0.16}Ru_{0.14}Mo_{0.70} | 1.0147 | 1.0300 | 0.9211 |
| 22 | 26 | 52 | Ir_{0.22}Ru_{0.26}Mo_{0.52} | 1.0114 | 0.9541 | 1.2975 |
| 20 | 16 | 64 | Ir_{0.20}Ru_{0.16}Mo_{0.64} | 1.0113 | 1.0145 | 0.9829 |
| 12 | 12 | 76 | Ir_{0.12}Ru_{0.12}Mo_{0.76} | 1.0093 | 1.0118 | 0.9864 |
| 10 | 12 | 78 | Ir_{0.10}Ru_{0.12}Mo_{0.78} | 1.0093 | 1.0026 | 1.0347 |
| 18 | 14 | 68 | Ir_{0.18}Ru_{0.14}Mo_{0.68} | 1.0083 | 1.0294 | 0.8900 |
| 80 | 4 | 16 | Ir_{0.80}Ru_{0.04}Mo_{0.16} | 1.0013 | 1.0352 | 0.8205 |
| 14 | 12 | 74 | Ir_{0.14}Ru_{0.12}Mo_{0.74} | 1.0009 | 1.0128 | 0.9372 |
| 20 | 14 | 66 | Ir_{0.20}Ru_{0.14}Mo_{0.66} | 0.9973 | 1.0189 | 0.8866 |
| 8 | 12 | 80 | Ir_{0.08}Ru_{0.12}Mo_{0.80} | 0.9973 | 0.9853 | 1.0627 |
| 22 | 24 | 54 | Ir_{0.22}Ru_{0.24}Mo_{0.54} | 1.9965 | 0.9485 | 1.2526 |
| 16 | 12 | 72 | Ir_{0.16}Ru_{0.12}Mo_{0.72} | 0.9884 | 1.0121 | 0.8732 |
| 12 | 10 | 78 | Ir_{0.12}Ru_{0.10}Mo_{0.78} | 0.9862 | 0.98882 | 0.9861 |
| 22 | 16 | 62 | Ir_{0.22}Ru_{0.16}Mo_{0.62} | 0.9860 | 0.9858 | 1.0009 |
| 22 | 18 | 60 | Ir_{0.22}Ru_{0.18}Mo_{0.60} | 0.9836 | 0.9658 | 1.0952 |
| 22 | 22 | 56 | Ir_{0.22}Ru_{0.22}Mo_{0.56} | 0.9833 | 0.9449 | 1.2054 |
| 14 | 10 | 76 | Ir_{0.14}Ru_{0.10}Mo_{0.76} | 0.9815 | 0.9966 | 0.9190 |
| 22 | 20 | 58 | Ir_{0.22}Ru_{0.20}Mo_{0.58} | 0.9806 | 0.9514 | 1.1564 |
| 18 | 12 | 70 | Ir_{0.18}Ru_{0.12}Mo_{0.70} | 0.9791 | 1.0122 | 0.8224 |
| 10 | 10 | 80 | Ir_{0.10}Ru_{0.10}Mo_{0.80} | 0.9786 | 0.9707 | 1.0425 |
| 64 | 0 | 36 | Ir_{0.64}Ru_{0.0}Mo_{0.36} | 0.9778 | 0.9742 | 1.0190 |
| 22 | 14 | 64 | Ir_{0.22}Ru_{0.14}Mo_{0.64} | 0.9736 | 0.9915 | 0.9037 |
| 6 | 12 | 82 | Ir_{0.06}Ru_{0.12}Mo_{0.82} | 0.9727 | 0.9500 | 1.1223 |
| 78 | 6 | 16 | Ir_{0.78}Ru_{0.06}Mo_{0.16} | 0.9696 | 0.9528 | 1.0885 |
| 8 | 10 | 82 | Ir_{0.08}Ru_{0.10}Mo_{0.82} | 0.9687 | 0.9521 | 1.0898 |
| 20 | 12 | 68 | Ir_{0.20}Ru_{0.12}Mo_{0.68} | 0.9681 | 1.0027 | 0.8120 |
| 16 | 10 | 74 | Ir_{0.16}Ru_{0.10}Mo_{0.74} | 0.9676 | 0.9983 | 0.8336 |
| 14 | 8 | 78 | Ir_{0.14}Ru_{0.08}Mo_{0.78} | 0.9638 | 0.9764 | 0.9313 |
| 12 | 8 | 80 | Ir_{0.12}Ru_{0.08}Mo_{0.80} | 0.9611 | 0.9564 | 1.0255 |
| 16 | 8 | 76 | Ir_{0.16}Ru_{0.08}Mo_{0.76} | 0.9587 | 0.9828 | 0.8671 |
| 18 | 10 | 72 | Ir_{0.18}Ru_{0.10}Mo_{0.72} | 0.9578 | 0.9984 | 0.7775 |
| 6 | 10 | 71 | Ir_{0.06}Ru_{0.10}Mo_{0.71} | 0.9573 | 0.9984 | 0.7775 |
| 22 | 12 | 66 | Ir_{0.22}Ru_{0.12}Mo_{0.6}6 | 0.9529 | 0.9868 | 0.8129 |
| 10 | 8 | 82 | Ir_{0.10}Ru_{0.08}Mo_{0.82} | 0.9496 | 0.9407 | 1.0493 |
| 20 | 10 | 70 | Ir_{0.02}Ru_{0.10}Mo_{0.70} | 0.9489 | 0.9936 | 0.7529 |
| 24 | 16 | 60 | Ir_{0.24}Ru_{0.16}Mo_{0.60} | 0.9484 | 0.9421 | 1.0346 |
| 24 | 24 | 52 | Ir_{0.24}Ru_{0.24}Mo_{0.52} | 0.9481 | 0.8930 | 1.3067 |
| 24 | 18 | 58 | Ir_{0.24}Ru_{0.18}Mo_{0.58} | 0.9440 | 0.9210 | 1.1281 |
| 24 | 14 | 62 | Ir_{0.24}Ru_{0.14}Mo_{0.62} | 0.9429 | 0.9560 | 0.9270 |
| 62 | 0 | 38 | Ir_{0.62}Ru_{0.0}Mo_{0.38} | 0.9416 | 0.9382 | 1.0191 |
| 18 | 8 | 74 | Ir_{0.18}Ru_{0.08}Mo_{0.74} | 0.9400 | 0.9830 | 0.7597 |
| 78 | 4 | 18 | Ir_{0.78}Ru_{0.04}Mo_{0.18} | 0.9382 | 1.0029 | 0.6392 |
| 24 | 20 | 56 | Ir_{0.24}Ru_{0.20}Mo_{0.56} | 0.9364 | 0.9014 | 1.1966 |
| 20 | 8 | 72 | Ir_{0.20}Ru_{0.08}Mo_{0.72} | 0.9360 | 0.9826 | 0.7388 |
| 24 | 22 | 54 | Ir_{0.24}Ru_{0.22}Mo_{0.54} | 0.9353 | 0.8902 | 1.2527 |
| 22 | 10 | 68 | Ir_{0.22}Ru_{0.10}Mo_{0.68} | 0.9349 | 0.9793 | 0.7508 |
| 8 | 8 | 84 | Ir_{0.08}Ru_{0.08}Mo_{0.84} | 0.9317 | 0.9181 | 1.0772 |
| 24 | 12 | 64 | Ir_{0.24}Ru_{0.12}Mo_{0.64} | 0.9267 | 0.9564 | 0.8316 |
| 22 | 8 | 70 | Ir_{0.22}Ru_{0.08}Mo_{0.70} | 0.9208 | 0.9717 | 0.7097 |
| 24 | 10 | 66 | Ir_{0.24}Ru_{0.10}Mo_{0.66} | 0.9152 | 0.9573 | 0.7586 |
| 24 | 8 | 68 | Ir_{0.24}Ru_{0.08}Mo_{0.68} | 0.9123 | 0.9626 | 0.7104 |
| 60 | 0 | 40 | Ir_{0.60}Ru_{0.0}Mo_{0.40} | 0.9093 | 0.9050 | 1.0249 |
| 26 | 16 | 58 | Ir_{0.26}Ru_{0.16}Mo_{0.58} | 0.9078 | 0.8956 | 1.0699 |
| 26 | 14 | 60 | Ir_{0.26}Ru_{0.14}Mo_{0.60} | 0.9060 | 0.9121 | 0.9654 |
| 26 | 18 | 56 | Ir_{0.26}Ru_{0.18}Mo_{0.56} | 0.8992 | 0.8698 | 1.1715 |
| 26 | 12 | 62 | Ir_{0.26}Ru_{0.12}Mo_{0.62} | 0.8973 | 0.9224 | 0.8528 |
| 26 | 20 | 54 | Ir_{0.26}Ru_{0.20}Mo_{0.54} | 0.8896 | 0.8473 | 1.2496 |
| 26 | 22 | 52 | Ir_{0.26}Ru_{0.22}Mo_{0.52} | 0.8885 | 0.8344 | 1.3200 |
| 26 | 10 | 64 | Ir_{0.26}Ru_{0.10}Mo_{0.64} | 0.8882 | 0.9260 | 0.7771 |
| 76 | 6 | 18 | Ir_{0.76}Ru_{0.06}Mo_{0.18} | 0.8875 | 0.9008 | 0.9214 |
| 6 | 8 | 86 | Ir_{0.06}Ru_{0.08}Mo_{0.86} | 0.8868 | 0.8606 | 1.1548 |
| 26 | 8 | 66 | Ir_{0.26}Ru_{0.08}Mo_{0.66} | 0.8825 | 0.9317 | 0.7070 |
| 58 | 0 | 42 | Ir_{0.58}Ru_{0.0}Mo_{0.42} | 0.8781 | 0.8732 | 1.0295 |
| 76 | 4 | 20 | Ir_{0.76}Ru_{0.04}Mo_{0.20} | 0.8745 | 0.9552 | 0.5153 |
| 28 | 14 | 58 | Ir_{0.28}Ru_{0.14}Mo_{0.58} | 0.8686 | 0.8689 | 0.9979 |
| 28 | 16 | 56 | Ir_{0.28}Ru_{0.16}Mo_{0.56} | 0.8652 | 0.8448 | 1.1241 |
| 28 | 16 | 64 | Ir_{0.28}Ru_{0.16}Mo_{0.64} | 0.8646 | 0.9100 | 0.7244 |
| 28 | 12 | 60 | Ir_{0.28}Ru_{0.12}Mo_{0.60} | 0.8632 | 0.8820 | 0.8857 |
| 28 | 10 | 62 | Ir_{0.28}Ru_{0.10}Mo_{0.62} | 0.8597 | 0.8944 | 0.7883 |
| 28 | 18 | 54 | Ir_{0.28}Ru_{0.18}Mo_{0.54} | 0.8576 | 0.8211 | 1.2234 |
| 28 | 20 | 52 | Ir_{0.28}Ru_{0.20}Mo_{0.52} | 0.8486 | 0.7969 | 1.3205 |
| 56 | 0 | 44 | Ir_{0.56}Ru_{0.0}Mo_{0.44} | 0.8475 | 0.8440 | 1.0219 |
| 72 | 8 | 20 | Ir_{0.72}Ru_{0.08}Mo_{0.20} | 0.8384 | 0.7965 | 1.2638 |
| 74 | 4 | 22 | Ir_{0.74}Ru_{0.04}Mo_{0.22} | 0.8343 | 0.9183 | 0.4715 |
| 74 | 6 | 20 | Ir_{0.74}Ru_{0.06}Mo_{0.20} | 0.8328 | 0.8688 | 0.7724 |
| 30 | 12 | 58 | Ir_{0.30}Ru_{0.12}Mo_{0.58} | 0.8248 | 0.8340 | 0.9410 |
| 30 | 14 | 56 | Ir_{0.30}Ru_{0.14}Mo_{0.56} | 0.8244 | 0.8117 | 1.0823 |
| 30 | 10 | 60 | Ir_{0.30}Ru_{0.10}Mo_{0.60} | 0.8241 | 0.8514 | 0.8264 |
| 30 | 8 | 62 | Ir_{0.30}Ru_{0.08}Mo_{0.62} | 0.8233 | 0.8662 | 0.7264 |
| 30 | 16 | 54 | Ir_{0.30}Ru_{0.16}Mo_{0.54} | 0.8225 | 0.7921 | 1.1940 |
| 30 | 18 | 52 | Ir_{0.30}Ru_{0.18}Mo_{0.52} | 0.8161 | 0.7691 | 1.3029 |
| 54 | 0 | 46 | Ir_{0.54}Ru_{0.0}Mo_{0.46} | 0.8157 | 0.8157 | 0.9998 |
| 32 | 8 | 60 | Ir_{0.32}Ru_{0.08}Mo_{0.60} | 0.7964 | 0.8274 | 0.7964 |
| 72 | 4 | 24 | Ir_{0.72}Ru_{0.04}Mo_{0.24} | 0.7893 | 0.8735 | 0.4403 |
| 70 | 8 | 22 | Ir_{0.70}Ru_{0.08}Mo_{0.22} | 0.7882 | 0.7645 | 1.1570 |
| 72 | 6 | 22 | Ir_{0.72}Ru_{0.06}Mo_{0.22} | 0.7868 | 0.8368 | 0.6665 |
| 52 | 0 | 48 | Ir_{0.52}Ru_{0.0}Mo_{0.48} | 0.7815 | 0.7880 | 0.9557 |
| 32 | 10 | 58 | Ir_{0.32}Ru_{0.10}Mo_{0.54} | 0.7789 | 0.7878 | 0.9399 |
| 32 | 16 | 52 | Ir_{0.32}Ru_{0.16}Mo_{0.52} | 0.7769 | 0.7314 | 1.3109 |
| 32 | 14 | 54 | Ir_{0.32}Ru_{0.14}Mo_{0.54} | 0.7767 | 0.7468 | 1.2014 |
| 32 | 12 | 56 | Ir_{0.32}Ru_{0.12}Mo_{0.56} | 0.7754 | 0.7642 | 1.0794 |

TABLE 13
Data for high overall performance on chip

| Iridium | Ruthenium | Molybdenum | Ratio | Relative | Relative | Relative |
|---|---|---|---|---|---|---|
| Composition | Composition | Composition | IrₓRu_{y}Mo_{z} | BOL | EOL | Stability |
| 82 | 0 | 18 | Ir_{0.82}Ru_{0.0}Mo_{0.18} | 1.2822 | 1.3118 | 0.8486 |
| 80 | 0 | 20 | Ir_{0.80}Ru_{0.0}Mo_{0.20} | 1.2304 | 1.2859 | 0.7324 |
| 78 | 0 | 22 | Ir_{0.78}Ru_{0.0}Mo_{0.22} | 1.1985 | 1.2685 | 0.6672 |
| 76 | 0 | 24 | Ir_{0.76}Ru_{0.0}Mo_{0.24} | 1.1674 | 1.2322 | 0.6885 |
| 74 | 0 | 26 | Ir_{0.74}Ru_{0.0}Mo_{0.26} | 1.1394 | 1.1911 | 0.7472 |
| 72 | 0 | 28 | Ir_{0.72}Ru_{0.0}Mo_{0.28} | 1.1051 | 1.1505 | 0.7705 |
| 70 | 0 | 30 | Ir_{0.70}Ru_{0.0}Mo_{0.30} | 1.0753 | 1.1079 | 0.8324 |
| 68 | 0 | 32 | Ir_{0.68}Ru_{0.0}Mo_{0.32} | 1.0464 | 1.0621 | 0.9185 |
| 18 | 16 | 66 | Ir_{0.18}Ru_{0.16}Mo_{0.66} | 1.0301 | 1.0354 | 0.9729 |
| 14 | 14 | 72 | Ir_{0.14}Ru_{0.14}Mo_{0.72} | 1.0269 | 1.0300 | 0.9840 |
| 16 | 14 | 70 | Ir_{0.16}Ru_{0.14}Mo_{0.70} | 1.0147 | 1.0300 | 0.9211 |
| 20 | 16 | 64 | Ir_{0.20}Ru_{0.16}Mo_{0.64} | 1.0113 | 1.0145 | 0.9829 |
| 12 | 12 | 76 | Ir_{0.12}Ru_{0.12}Mo_{0.76} | 1.0093 | 1.0118 | 0.9864 |
| 18 | 14 | 68 | Ir_{0.18}Ru_{0.14}Mo_{0.68} | 1.0083 | 1.0294 | 0.8900 |
| 80 | 4 | 16 | Ir_{0.80}Ru_{0.0}4Mo_{0.16} | 1.0013 | 1.0352 | 0.8205 |
| 14 | 12 | 74 | Ir_{0.14}Ru_{0.12}Mo_{0.74} | 1.0009 | 1.0128 | 0.9372 |

TABLE 14
Preferred Catalyst Composition Ranges Based on Overall PEM Electrolyzer Performance

| Iridium | Iridium | | Ruthenium | Ruthenium | | Molybdenum | Molybdenum | | | |
|---|---|---|---|---|---|---|---|---|---|---|
| Min | Max | Iridium | Min | Max | Ruthenium | Min | Max | Molybdenum | SEMECD | |
| avg | avg | at % | avg | avg | at % | avg | avg | at % | avg | SEMECD |
| at % | at % | deviation | at % | at % | deviation | at % | at % | deviation | (um) | deviation |
| 14 | 17 | 9 | 70 | 75 | 9 | 8 | 17 | 2 | 0.25 | 0.33 |
| 56 | — | 33 | — | — | — | 43 | — | 33 | 0.09 | 0.2 |

| 3 | 3 | | | | | | | | | | |
|---|---|---|---|---|---|---|---|---|---|---|---|
| electrode | electrode | | | | | | | | | | |
| activity | activity | 3 | 3 | PEM | PEM | | | | | | |
| min | max | electrode | electrode | electrolyzer | electrolyzer | | | | | SqW | SqW |
| (uA/ug | (uA/ug | durability | durability | loading | loading | CCM | CCM | BOL | BOL | % | % |
| @1.8 V | @1.8 V | min | max | min | max | min | max | min | max | min | max |
| vs | vs | % | % | (mg/ | (mg/ | Resistance | Resistance | A/ | A/ | loss/ | loss/ |
| RHE) | RHE) | loss | loss | cm²) | cm²) | mΩ | mΩ | cm² | cm² | hr | hr |
| 4736 | 5879 | 0.09 | 0.22 | 0.53 | — | — | — | 7 | — | −0.02 | — |
| 2619 | — | 0.14 | — | 0.35 | — | 40 | — | 0.12 | — | 0.04 | — |

TABLE 15
Individual data for preferred overall PEM electrolyzer performance

| Iridium | | Ruthenium | | Molybdenum | | |
|---|---|---|---|---|---|---|
| avg | Iridium | avg | Ruthenium | avg | Molybdenum | Ratio |
| at % | stdev | at % | stdev | at % | stdev | IrₓRu_{y}Mo_{z} |
| 100 | 0 | — | — | — | — | Ir_{1.0} |
| | | | | | | Ru₀ |
| | | | | | | Mo₀ |
| 39 | 23 | — | — | 61 | 23 | Ir_{0.39} |
| | | | | | | Ru₀ |
| | | | | | | Mo_{0.61} |
| 14 | 10 | 70 | 8 | 17 | 2 | Ir_{0.14} |
| | | | | | | Ru_{0.70} |
| | | | | | | Mo_{0.17} |
| 16 | 5 | 69 | 8 | 16 | 3 | Ir_{0.16} |
| | | | | | | Ru_{0.69} |
| | | | | | | Mo_{0.16} |
| 14 | 6 | 69 | 10 | 16 | 3 | Ir_{0.14} |
| | | | | | | Ru_{0.69} |
| | | | | | | Mo_{0.16} |

| | | 3-Electrode | | | | | |
|---|---|---|---|---|---|---|---|
| Particle | | Activity | | | | | |
| Size | | (uA/ug | | PEM Electrolyzer | | | |
| SEMECD | | @ 1.8 V | | | | | SqW |
| avg, | SEMECD | vs | Durability | Loading | CCMR | BOL | % |
| um | stdev | RHE) | % loss | (mg/cm²) | mΩ | A/cm² | loss/hr |
| 0.09 | 0.07 | 2436 | −0.01 | 0.711 | 40 | 1.51 | 0.03 |
| — | — | 26194 | 0.14 | 0.35 | 108 | 0.12 | — |
| 0.13 | 0.2 | 5879 | 0.09 | 0.53 | — | 3.07 | −0.02 |
| 0.17 | 0.20 | 4736 | 0.22 | — | — | — | — |
| 0.13 | 0.20 | 5379 | 0.10 | — | — | — | — |

CLAUSES, within the Present Disclosure:
CLAUSE [1]: A catalyst comprising a mixed metal including Ir, Ru, and Mo.
CLAUSE [2]: The catalyst of any preceding clause, wherein the concentration of Ir is within a range from 2 to 91 at %, the concentration of Ru is within a range from 2 to 90 at %, and the concentration off Mo is within a range from 2 to 86 at %.
CLAUSE [3]: The catalyst of any preceding clause, wherein the concentration of Ir is within a range from 5 to 26 at %.
CLAUSE [4]: The catalyst of any preceding clause, wherein the concentration of Ir is within a range from 7 to 24 at %.
CLAUSE [5]: The catalyst of any preceding clause, wherein the concentration of Ir is within a range from 9 to 22 at %.
CLAUSE [6]: The catalyst of any preceding clause, wherein the concentration of Ru is within a range from 61 to 84 at %.
CLAUSE [7]: The catalyst of any preceding clause, wherein the concentration of Ru is within a range from 63 to 82 at %.
CLAUSE [8]: The catalyst of any preceding clause, wherein the concentration of Ru is within a range from 65 to 80 at %.
CLAUSE [9]: The catalyst of any preceding clause, wherein the concentration of Mo is within a range from 6 to 19 at %.
CLAUSE [10]: The catalyst of any preceding clause, wherein the concentration of Mo is within a range from 8 to 18 at %.
CLAUSE [11]: The catalyst of any preceding clause, wherein the concentration of Mo is within a range from 10 to 17 at %.
CLAUSE [12]: The catalyst of any preceding clause, wherein the metallics comprise a single phase.
CLAUSE [13]: The catalyst of any preceding clause, wherein the metallics comprise mixed phase(s).
CLAUSE [14]: The catalyst of any preceding clause, wherein one or more metallics within the catalyst are oxidized.
CLAUSE [15]: The catalyst of any preceding clause, wherein the oxide can vary in crystallinity from amorphous to fully crystalline.
CLAUSE [16]: The catalyst of any preceding clause, wherein a ratio of oxide to metallic is fully oxidized, partially oxidized, or fully metallic.
CLAUSE [17]: The catalyst of any preceding clause, wherein the oxide is created via thermal annealing, calcination, chemically, or electrochemically.
CLAUSE [18]: The catalyst of any preceding clause, wherein the catalyst is unsupported, or supported on carbon, alumina, titanium, titania, niobium, zirconium, tantalum, antimony, silicon carbide, palladium, platinum, or silica.
CLAUSE [19]: The catalyst of any preceding clause, wherein the catalyst contains up to 10 atomic % of additional elements, such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, and/or Cu.
CLAUSE [20]: The catalyst of any preceding clause, wherein a surface of the catalyst is nanostructured.
CLAUSE [21]: The catalyst of any preceding clause, wherein the catalyst synthesis includes one or more of melt fusion, templated thermal decomposition, colloidal synthesis, sol-gel hydrolysis, electrodeposition, polymer pen lithography, and/or spray pyrolysis.
CLAUSE [22]: The catalyst of any preceding clause, wherein the catalyst is a catalytic layer in an electrode suitable for oxygen evolution in electrolytic processes.
CLAUSE [23]: The catalyst of any preceding clause, wherein the catalytic layer comprises mixed metals or metal oxides of iridium and at least one other element Ru or Mo.
CLAUSE [24]: The catalyst of any preceding clause, wherein the catalytic layer obtained by application of a solution containing precursors of the elements to the substrate and subsequently decomposition of the solution by a thermal treatment in air, oxygen, argon at a temperature of 300 to 600° C. to obtain an average crystallite size of said mixed metals or metal oxides lower than 50 nm.
CLAUSE [25]: The catalyst of any preceding clause, wherein a protective layer interposed between the substrate and the catalytic layer.
CLAUSE [26]: A method of catalyzing electrochemical reaction, comprising:
providing a mixed metal including at least two metallics, wherein a first of the metallics is Ir, and the metallics include at least one of Ru or W; and
applying the mixed metal as a catalyst in a reaction.
CLAUSE [27]: The method of any preceding clause, wherein the composition of the catalyst and the atomic ratio of the metallics is defined from at least one of those disclosed within the collection of the Tables 1-15 and FIGS. 1-18.
CLAUSE [28]: The method of any preceding clause, wherein one or more metallics within the catalyst are oxidized.
CLAUSE [29]: The method of any preceding clause, wherein the oxide can vary in crystallinity from amorphous to fully crystalline.
CLAUSE [30]: The method of any preceding clause, wherein the ratio of oxide to metallic is fully oxidized, partially oxidized, or fully metallic.
CLAUSE [31]: The method of any preceding clause, wherein the oxide is the result of thermal annealing, calcination, chemical treatment or electrochemical treatment.
CLAUSE [32]: The method of any preceding clause, wherein the catalyst is unsupported or supported on carbon, alumina, titanium, titania, niobium, zirconium, tantalum, antimony, silicon carbide, palladium, platinum, or silica.
CLAUSE [33]: The method of any preceding clause, wherein the catalyst contains up to 10 atomic % of additional elements, such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, and/or Cu.
CLAUSE [34]: The method of any preceding clause, wherein a surface of the catalyst is nanostructured.
CLAUSE [35]: The method of any preceding clause, wherein the catalyst synthesis includes one or more of melt fusion, templated thermal decomposition, colloidal synthesis, sol-gel hydrolysis, electrodeposition, and/or spray pyrolysis.
CLAUSE [36]: The method of any preceding clause, wherein applying the catalyst in the reaction includes applying the catalyst for Oxygen Evolution Reaction (OER).
CLAUSE [37]: The method of any preceding clause, wherein the OER reaction is an acidic OER.
CLAUSE [38]: The method of any preceding clause, wherein the OER reaction is an alkaline OER.
CLAUSE [39]: The method of any preceding clause, wherein applying the catalyst in the reaction includes applying the catalyst for hydrogen generation and/or oxidation.
CLAUSE [40]: The method of any preceding clause, wherein applying the catalyst in the reaction includes applying the catalyst for oxygen generation and/or reduction.
CLAUSE [41]: The method of any preceding clause, wherein applying the catalyst in the reaction includes applying the catalyst for CO₂ conversion.
CLAUSE [42]: The method of any preceding clause, wherein applying the catalyst in the reaction includes applying the catalyst for biomass conversion to organic products.
CLAUSE [43]: The method of any preceding clause, wherein applying the catalyst in the reaction includes applying the catalyst for hydrogenation and/or dehydrogenation.
CLAUSE [44]: The method of any preceding clause, wherein applying the catalyst in the reaction includes applying the catalyst for organic oxidation reactions.
CLAUSE [45]: The method of any preceding clause, wherein applying the catalyst in the reaction includes applying the catalyst for the generation of halogen gases.
CLAUSE [46]: The method of any preceding clause, wherein applying the catalyst in the reaction includes applying the catalyst for ammonia generation and/or conversion.
CLAUSE [47]: The method of any preceding clause, wherein applying the catalyst in the reaction includes applying the catalyst for gas purification.
CLAUSE [48]: The method of any preceding clause, wherein applying the catalyst in the reaction includes applying the catalyst for deoxygenation, dehydrogenation, and/or CO₂ cleaning.
CLAUSE [49]: The method of any preceding clause, wherein applying the catalyst in the reaction includes applying the catalyst for the process of cathodic electrodeposition, electrowinning, electroplating of metals, chlorine production causing anodic evolution of oxygen on the surface of an electrode.
CLAUSE [50]: The catalyst or method of any preceding claim, wherein the concentration of one of Ir, Ru, and/or Mo is zero.
CLAUSE [51]: The catalyst or method of any preceding claim, wherein the concentration of Ir, Ru, and/or Mo is defined as an average concentration within the catalyst.

Accordingly, the various embodiments of the invention, as disclosed above, are intended to be illustrative, not limiting. Various changes may be made without departing from the spirit and scope of the invention. As a result, it will be apparent for those skilled in the art that the illustrative embodiments described are only examples and that various modifications can be made within the scope of the invention as defined in the appended claims.

We claim:

1. A catalyst comprising a mixed metal including Ir, Ru, and Mo.

2. The catalyst of claim 1, wherein the concentrations of Ir, Ru and Mo relative to each other are on average Ir (2 to 91 at %), Ru (2 to 90 at %), and Mo (2-86 at %).

3. The catalyst of claim 1, wherein the concentrations of Ir, Ru and Mo relative to each other are on average Ir (7-87 at %), Ru (10-86 at %), and Mo (3-27 at %).

4. The catalyst of claim 1, wherein the average concentration of Ir relative to the concentrations of Ir, Ru and Mo is within a range from 5 to 26 at %.

5. The catalyst of claim 1, wherein the average concentration of Ir relative to the concentrations of Ir, Ru and Mo is within a range from 7 to 24 at %.

6. The catalyst of claim 1, wherein the concentrations of Ir, Ru and Mo relative to each other are on average Ir (9-22 at %), Ru (65-80 at %), and Mo (10-17 at %).

7. The catalyst of claim 1, wherein the average concentration of Ru relative to the concentrations of Ir, Ru and Mo is within a range from 61 to 84 at %.

8. The catalyst of claim 1, wherein the average concentration of Ru relative to the concentrations of Ir, Ru and Mo is within a range from 63 to 82 at %.

9. The catalyst of claim 1, wherein the average concentration of Ru relative to the concentrations of Ir, Ru and Mo is within a range from 65 to 80 at %.

10. The catalyst of claim 1, wherein the average concentration of Mo relative to the concentrations of Ir, Ru and Mo is within a range from 6 to 19 at %.

11. The catalyst of claim 1, wherein the average concentration of Mo relative to the concentrations of Ir, Ru and Mo is within a range from 8 to 18 at %.

12. The catalyst of claim 1, wherein the average concentration of Mo relative to the concentrations of Ir, Ru and Mo is within a range from 10 to 17 at %.

13. The catalyst of claim 1, wherein the metallics comprise a single or mixed phase(s).

14. The catalyst of claim 1, wherein one or more metallics within the catalyst are oxidized.

15. The catalyst of claim 14, wherein the oxide can vary in crystallinity from amorphous to fully crystalline.

16. The catalyst of claim 14, wherein a ratio of oxide to metallic is fully oxidized, partially oxidized, or fully metallic.

17. The catalyst of claim 14, wherein the oxide is created via thermal annealing, calcination, chemically, or electrochemically.

18. The catalyst of claim 1, wherein the catalyst is unsupported, or supported on carbon, alumina, titanium, titania, niobium, zirconium, tantalum, antimony, silicon carbide, palladium, platinum, or silica.

19. The catalyst of claim 1, wherein the catalyst contains up to 10 atomic % of additional elements, such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, and/or Cu.

20. The catalyst of claim 1, wherein a surface of the catalyst is nanostructured.

21. The catalyst of claim 1, wherein the catalyst synthesis includes one or more of melt fusion, templated thermal decomposition, colloidal synthesis, sol-gel hydrolysis, electrodeposition, polymer pen lithography, and/or spray pyrolysis.

22. The catalyst of claim 1, wherein the catalyst is a catalytic layer in an electrode suitable for oxygen evolution in electrolytic processes.

23. The catalyst of claim 22, wherein the catalytic layer comprises mixed metals or metal oxides of iridium and at least one other element Ru or Mo.

24. The catalyst of claim 22, wherein the catalytic layer obtained by application of a solution containing precursors of the elements to the substrate and subsequently decomposition of the solution by a thermal treatment in air, oxygen, argon at a temperature of 300 to 600° C. to obtain an average crystallite size of said mixed metals or metal oxides lower than 50 nm.

25. The catalyst of claim 22, wherein a protective layer interposed between the substrate and the catalytic layer.

26. A method of catalyzing electrochemical reaction, comprising:
providing a mixed metal including at least two metallics, wherein a first of the metallics is Ir, and the metallics include at least one of Ru or Mo; and
applying the mixed metal as a catalyst in a reaction.

27. The method of claim 26, wherein the composition of the catalyst and the atomic ratio of the metallics is defined from at least one of those disclosed within the collection of the Tables 1-15 and FIGS. 1-18.

28. The method of claim 26, wherein one or more metallics within the catalyst are oxidized.

29. The method of claim 28, wherein the oxide can vary in crystallinity from amorphous to fully crystalline.

30. The method of claim 28, wherein the ratio of oxide to metallic is fully oxidized, partially oxidized, or fully metallic.

31. The method of claim 28, wherein the oxide is the result of thermal annealing, calcination, chemical treatment or electrochemical treatment.

32. The method of claim 26, wherein the catalyst is unsupported or supported on carbon, alumina, titanium, titania, niobium, zirconium, tantalum, antimony, silicon carbide, palladium, platinum, or silica.

33. The method of claim 26, wherein the catalyst contains up to 10 atomic % of additional elements, such as Mo, Re, Fe, Cr, Mn, Rh, Pd, Pt, W, Os, Ta, Ce, Ba, Hf, In, Sn, Sb, Au, Ag, Sr, Y, Sc, Nb, La, Pr, Sm, and/or Cu.

34. The method of claim 26, wherein a surface of the catalyst is nanostructured.

35. The method of claim 26, wherein the catalyst synthesis includes one or more of melt fusion, templated thermal decomposition, colloidal synthesis, sol-gel hydrolysis, electrodeposition, and/or spray pyrolysis.

36. The method of claim 26, wherein applying the catalyst in the reaction includes applying the catalyst for Oxygen Evolution Reaction (OER).

37. The method of claim 36, wherein the OER reaction is an acidic OER.

38. The method of claim 36, wherein the OER reaction is an alkaline OER.

39. The method of claim 26, wherein applying the catalyst in the reaction includes applying the catalyst for hydrogen generation and/or oxidation.

40. The method of claim 26, wherein applying the catalyst in the reaction includes applying the catalyst for oxygen generation and/or reduction.

41. The method of claim 26, wherein applying the catalyst in the reaction includes applying the catalyst for CO₂ conversion.

42. The method of claim 26, wherein applying the catalyst in the reaction includes applying the catalyst for biomass conversion to organic products.

43. The method of claim 26, wherein applying the catalyst in the reaction includes applying the catalyst for hydrogenation and/or dehydrogenation.

44. The method of claim 26, wherein applying the catalyst in the reaction includes applying the catalyst for organic oxidation reactions.

45. The method of claim 26, wherein applying the catalyst in the reaction includes applying the catalyst for the generation of halogen gases.

46. The method of claim 26, wherein applying the catalyst in the reaction includes applying the catalyst for ammonia generation and/or conversion.

47. The method of claim 26, wherein applying the catalyst in the reaction includes applying the catalyst for gas purification.

48. The method of claim 26, wherein applying the catalyst in the reaction includes applying the catalyst for deoxygenation, dehydrogenation, and/or CO₂ cleaning.

49. The method of claim 26, wherein applying the catalyst in the reaction includes applying the catalyst for the process of cathodic electrodeposition, electrowinning, electroplating of metals, chlorine production causing anodic evolution of oxygen on the surface of an electrode.
